(19) United States
(12) Patent Application Publication
(10) Pub. No.: US 2024/0160890 A1
(43) Pub. Date: May 16, 2024

(54) SYSTEMS AND METHODS FOR CONTRASTIVE GRAPHING

(71) Applicant: ADOBE INC., San Jose, CA (US)

(72) Inventors: Namyong Park, Pittsburgh, PA (US); Ryan A. Rossi, San Jose, CA (US); Eunyee Koh, Sunnyvale, CA (US); Iftikhar Ahamath Burhanuddin, Bangalore (IN); Sungchul Kim, San Jose, CA (US); Fan Du, Milpitas, CA (US)

(21) Appl. No.: 18/052,463

(22) Filed: Nov. 3, 2022

(51) Int. Cl. G06N 3/04; G06N 3/08

(52) U.S. Cl. CPC G06N 3/04; G06N 3/08

(57) ABSTRACT

Systems and methods for contrastive graphing are provided. One aspect of the systems and methods includes receiving a graph including a node; generating a node embedding for the node based on the graph using a graph neural network (GNN); computing a contrastive learning loss based on the node embedding; and updating parameters of the GNN based on the contrastive learning loss.

### BACKGROUND

The following relates to content customization based on graph clustering. Data representing interactions of various entities in an entity network can be received from various web-based platforms (such as social networks). Examples of such interactions include check-in records and user interaction logs. Groups of similar entities can be identified based on the data.

In some cases, the data and the entity network can be represented as a graph in which entities that participate in the network are represented as nodes and interactions between the entities are represented as edges that connect the nodes. Conventional graphing systems attempt to identify similar groups of users based on the graph, but do not effectively consider temporal-spatial information represented by information included in the graph, or personas or roles of entities associated with the graph. There is therefore a need in the art for systems and methods that effectively identify groups of entities within an entity network based on an entity interaction graph.

### SUMMARY

Embodiments of the present disclosure provide systems and methods for finding and tracking an evolution of a community of entities. For example, an embodiment of the present disclosure uses contrastive graph clustering for community detection and tracking to provide an end-to-end framework for graph clustering. According to some aspects, a contrastive graphing system uses contrastive learning to learn node embeddings and cluster assignments of a graph, where the contrastive graphing system selects positive and negative samples in a multi-level scheme to reflect hierarchical community structures and network homophily of entities corresponding to nodes of the graph. In some cases, the contrastive graphing system uses contrastive learning to segment time-evolving graph data, where temporal graph clustering is performed by incremental learning with an ability to detect change points in the time-evolving graph data.

According to some aspects, by clustering nodes of the graph based on the learned node embeddings, the contrastive graphing system is able to segment users more accurately than conventional systems, and can therefore more accurately tailor (e.g., customize) content for users according to the segmentation.

A method, apparatus, non-transitory computer readable medium, and system for contrastive graphing are described. One or more aspects of the method, apparatus, non-transitory computer readable medium, and system include receiving a graph including a node; generating a node embedding for the node based on the graph using a graph neural network (GNN); computing a contrastive learning loss based on the node embedding; and updating parameters of the GNN based on the contrastive learning loss.

A method, apparatus, non-transitory computer readable medium, and system contrastive graphing are described. One or more aspects of the method, apparatus, non-transitory computer readable medium, and system include receiving a plurality of graph snapshots; generating a node embedding for each of the plurality of graph snapshots using a graph neural network (GNN); identifying a snapshot segment including a subset of the plurality of graph snapshots based on the node embedding; and generating a merged graph based on the subset of the plurality of graph snapshots in the snapshot segment.

An apparatus and system for contrastive graphing are described. One or more aspects of the apparatus and system include a processor; a memory storing instructions executable by the processor; a graph neural network (GNN) configured to generate a node embedding for a node based on a graph; and a training component configured to compute a contrastive learning loss based on the node embedding and update parameters of the GNN based on the contrastive learning loss.

### BRIEF DESCRIPTION OF THE DRAWINGS

FIG. 1 shows an example of a contrastive graphing system according to aspects of the present disclosure.

FIG. 2 shows an example of a content customization apparatus according to aspects of the present disclosure.

FIG. 3 shows a first example of data flow in a contrastive graphing system according to aspects of the present disclosure.

FIG. 4 shows a second example of data flow in a contrastive graphing system according to aspects of the present disclosure.

FIG. 5 shows an example of providing customized content according to aspects of the present disclosure.

FIG. 6 shows an example of training a graph neural network according to aspects of the present disclosure.

FIG. 7 shows a table of symbols according to aspects of the present disclosure.

FIG. 8 shows an example of an algorithm for contrastive graph clustering according to aspects of the present disclosure.

FIG. 9 shows an example of computing a node feature loss according to aspects of the present disclosure.

FIG. 10 shows an example of determining a node feature loss according to aspects of the present disclosure.

FIG. 11 shows an example of computing a network homophily loss according to aspects of the present disclosure.

FIG. 12 shows an example of determining a network homophily loss according to aspects of the present disclosure.

FIG. 13 shows an example of computing a hierarchical community loss according to aspects of the present disclosure.

FIG. 14 shows an example of determining a hierarchical community loss according to aspects of the present disclosure.

FIG. 15 shows an example of generating a merged graph according to aspects of the present disclosure.

FIG. 16 shows an example of an algorithm for temporal graph clustering according to aspects of the present disclosure.

FIG. 17 shows an example of computing a distance between a snapshot and a snapshot segment according to aspects of the present disclosure.

FIG. 18 shows an example of an algorithm for graph stream segmentation according to aspects of the present disclosure.

FIG. 19 shows an example of computing a temporal consistency loss according to aspects of the present disclosure.

FIG. 20 shows an example of determining a temporal consistency loss according to aspects of the present disclosure.

### DETAILED DESCRIPTION

Embodiments of the present disclosure relate to content customization based on graph clustering. Data representing interactions of various entities in an entity network can be received from various web-based platforms (such as social networks). Examples of such interactions include check-in records and user interaction logs. Groups of similar entities can be identified based on the data.

In some cases, the data and the entity network can be represented as a graph in which entities that participate in the network are represented as nodes and interactions between the entities are represented as edges that connect the nodes. Conventional graphing systems attempt to identify similar groups of users based on the graph, but do not effectively consider temporal-spatial information represented by information included in the graph, or personas or roles of entities associated with the graph.

For example, some conventional graphing systems may employ deep clustering (DGC) methods that learn node representations and cluster assignments in a joint optimization framework. However, existing DGC methods are mainly based on autoencoders and use a same clustering objective with relatively minor adaptations. Additionally, existing DGC methods are ineffective in processing dynamic user interaction graphs.

According to an aspect of the present disclosure, a contrastive graphing system is provided. In some embodiments, the contrastive graphing system receives a graph including a node, generates a node embedding for the node based on the graph using a graph neural network, computes a contrastive learning loss based on the node embedding, and updates parameters of the graph neural network based on the contrastive learning loss.

By using contrastive learning to update parameters of the graph neural network and using the updated graph neural network to generate an embedding of the node, the contrastive graphing system effectively considers spatial information represented by information included in the graph to determine a cluster of similar node embeddings that is representative of a community of entities. By grouping nodes of the graph based on the cluster of node embeddings, the contrastive graphing system is able to segment users in a more accurate manner than conventional systems can provide, and can therefore more accurately tailor (e.g., customize) content for users according to the segmentation.

An embodiment of the present disclosure provides contrastive graphing systems and methods to find communities of entities in an unsupervised manner when events between two entities are provided. Additionally, community detection and evolution tracking can be performed when the events are associated with time. In some cases, the graph neural network provides an effective framework that propagates and aggregates node features over the graph, thereby helping to learn node embeddings that reflect a network homophily of an entity network corresponding to the graph.

An embodiment of the present disclosure uses contrastive learning to pull an entity and a corresponding positive sample close to each other in an embedding space, while pushing the entity away from a corresponding negative sample. In some examples, the entity may be referred to as an anchor. Thus, positive samples may be obtained by taking different views of data represented by the graph, while negative samples are randomly selected from the entire pool of samples. An embodiment of the present disclosure uses a multi-level contrastive objective to choose positive and negative samples that reflect underlying hierarchical communities and associated semantics included in the entity network represented by the graph. Additionally, by using contrastive learning, embodiments of the present disclosure maximize mutual information between an entity and associated hierarchical communities in the latent space. Furthermore, according to some aspects, node cluster memberships and node embeddings are iteratively optimized in an end-to-end framework guided by the multi-level contrastive objective.

Furthermore, according to an aspect of the present disclosure, a contrastive graphing system is provided. In some embodiments, the contrastive graphing system receives a set of graph snapshots, generates a node embedding for each of the set of graph snapshots using a graph neural network, identifies a snapshot segment including a subset of the set of graph snapshots based on the node embedding, and generates a merged graph based on the subset of the set of graph snapshots in the snapshot segment.

By generating node embeddings based on the set of graph snapshots, and generating a merged graph based on the node embeddings, the contrastive graphing system is able to effectively consider temporal-spatial information represented by information included in the set of graph snapshots, and is able to understand and group entities based on time-evolving communities of entities represented by information included in the set of graph snapshots.

An embodiment of the present disclosure uses a temporal graph clustering setting to find communities of similar entities from time-evolving data represented by the set of graph snapshots. In some embodiments, entity representations and cluster memberships are updated to reflect new information that is obtained upon an arrival of new events in a new graph snapshot. Additionally, in some cases, a temporal smoothness assumption is incorporated into the graph neural network and the contrastive learning objective at the same time, thereby enabling the contrastive graphing system to adapt to changing community structures in a controlled manner.

An embodiment of the present disclosure is used in a user-clustering context. For example, the user is a participant in a social network and interacts with other social network users and entities that participate in the social network (such as software applications, organizations, websites, storefronts, etc.). In some cases, the contrastive graphing system receives a graph representing of the interactions that occur among entities that participate in the social network. The contrastive graphing system uses a graph neural network to generate embeddings of nodes in the graph that correspond to the entities.

In some cases, the contrastive graphing system uses a contrastive learning loss that is based on positive and negative samples drawn from the graph to update parameters of the graph neural network, thereby refining the graph neural network's node embedding output. In some cases, the positive and negative samples are identified in such a manner that the graph neural network's understanding of the entities' attributes, network homophily of the social network, and hierarchical community structures within the social network is increased.

In some cases, the contrastive graphing system assigns a node embedding corresponding to a user to one or more clusters, and provides customized content to the user based on the assignment. For example, in some cases, the customized content is a dashboard service relating to the social network. Based on the cluster assignment, the dashboard service can provide relevant information to the user that helps the user understand their role or persona within the social network. For example, the user may be identified as a particular type of employee with a defined role within an organization based on the cluster assignment, and the contrastive graphing system can provide information that is relevant to the user's role within the organization to the user via the dashboard service.

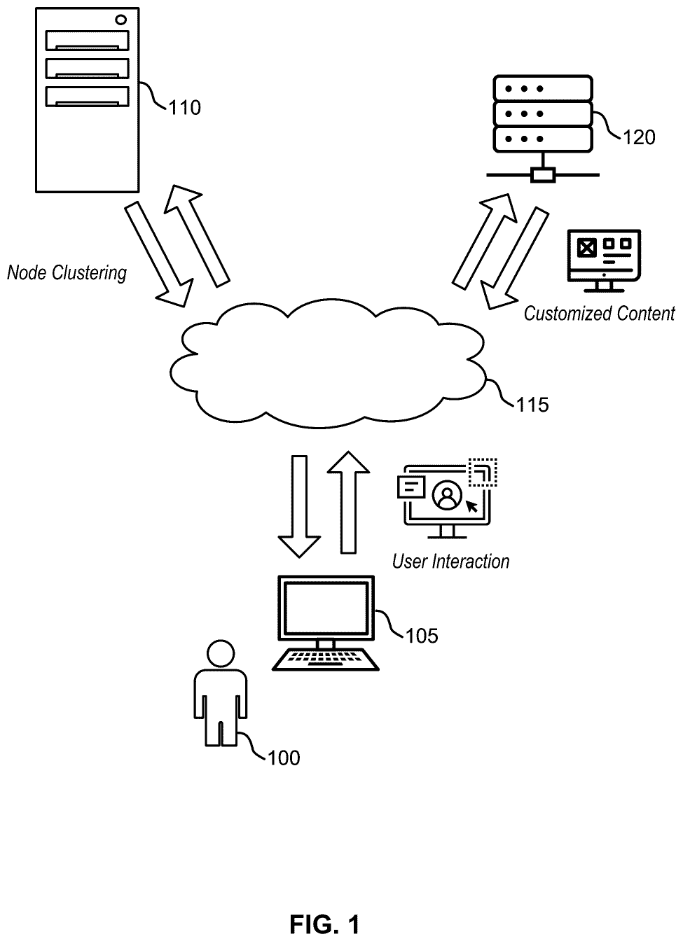

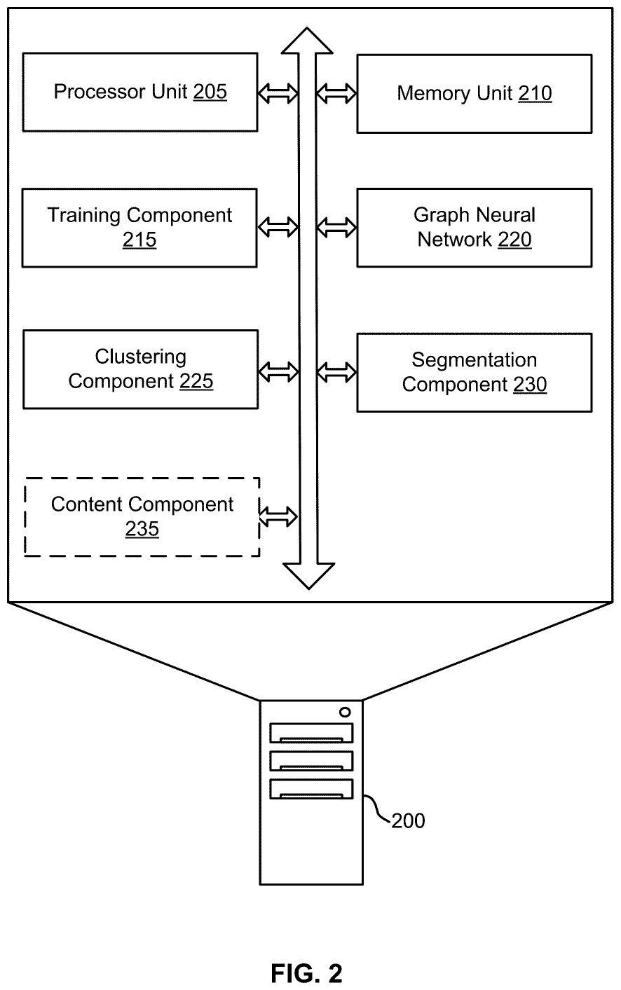

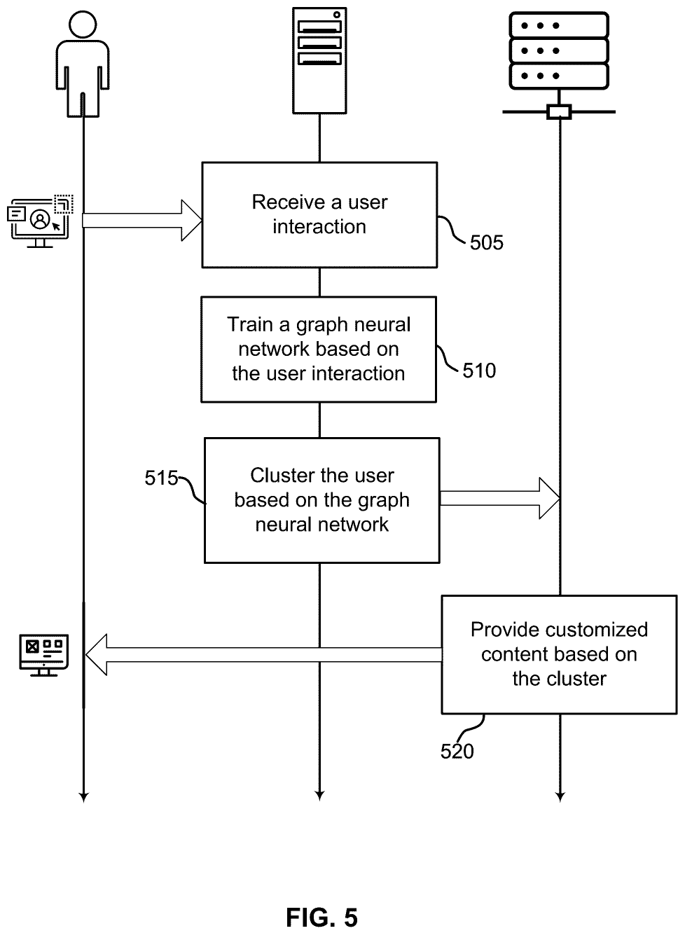

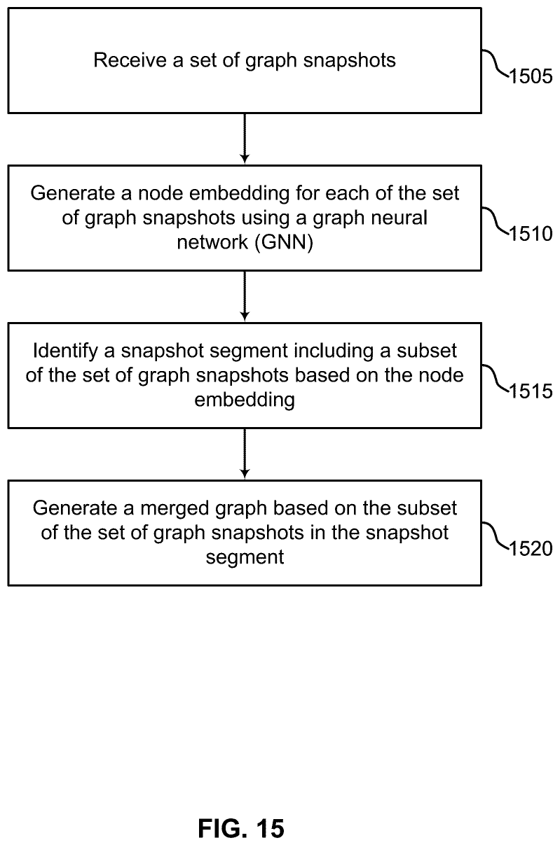

Example applications of the present disclosure in the user-clustering context are provided with reference to FIGS. 1 and 5. Details regarding the architecture of the contrastive graphing system are provided with reference to FIGS. 2-4. Examples of a process for contrastive graph clustering are provided with reference to FIGS. 5-14. Examples of a process for temporal contrastive graph clustering are provided with reference to FIGS. 15-20.

### Contrastive Graphing System

A system and apparatus for contrastive graphing is described with reference to FIGS. 1-4. One or more aspects of the system and apparatus include a processor; a memory storing instructions executable by the processor; a graph neural network (GNN) configured to generate a node embedding for a node based on a graph; and a training component configured to compute a contrastive learning loss based on the node embedding and update parameters of the GNN based on the contrastive learning loss.

Some examples of the system and apparatus further include a clustering component configured to cluster nodes of the graph based on the node embedding. Some examples of the system and apparatus further include a segmentation component configured to segment a plurality of graph snapshots based on an output of the GNN.

FIG. 1 shows an example of a contrastive graphing system according to aspects of the present disclosure. The example shown includes user 100, user device 105, content customization apparatus 110, cloud 115, and content distribution apparatus 120. Content customization apparatus 110 is an example of, or includes aspects of, the corresponding element described with reference to FIG. 2.

Referring to FIG. 1, user 100 interacts with another entity, such as a third-party user (e.g., organization), a physical location, a computing device, software, a website, or any other person or thing that is capable of interacting with another person or thing, via user device 105. In some cases, the user interaction is added to a graph in which entities are represented by nodes and interactions between entities are represented as edges between nodes. In some cases, content customization apparatus 110 receives the graph and uses contrastive learning techniques to assign a node embedding corresponding to the user to a cluster of node embeddings.

Content customization apparatus 110 provides a cluster assignment to content distribution apparatus 120. Based on the cluster assignment, content distribution apparatus 120 provides customized content to user 100 via user device 105. In an example, the customized content is content that relates to the user and other entities corresponding to node embeddings that are included in the one or more clusters that the node embedding corresponding to user 100 belongs to.

According to some aspects, user device 105 is a personal computer, laptop computer, mainframe computer, palmtop computer, personal assistant, mobile device, or any other suitable processing apparatus. In some examples, user device 105 includes software that allows user 100 to interact with other entities (such as a web browser, an app, etc.) and to receive content from content distribution apparatus 120.

According to some aspects, a user interface enables user 100 to interact with user device 105 and/or content distribution apparatus 120. In some embodiments, the user interface may include an audio device, such as an external speaker system, an external display device such as a display screen, or an input device (e.g., a remote control device interfaced with the user interface directly or through an I/O controller module). In some cases, the user interface may be a graphical user interface (GUI). According to some aspects, the user interface is included in content customization apparatus 110 and/or content distribution apparatus 120, and user 100 interacts directly with content customization apparatus 110 and/or content distribution apparatus 120 via the user interface. According to some aspects, the user interface is provided by content customization apparatus 110 or content distribution apparatus 120 via user device 105, and user 100 interacts with content customization apparatus 110 or content distribution apparatus 120 via the user interface.

According to some aspects, content customization apparatus 110 includes a computer implemented network. In some embodiments, the computer implemented network includes one or more artificial neural networks (ANNs). In some embodiments, content customization apparatus 110 also includes one or more processors, a memory subsystem, a communication interface, an I/O interface, one or more user interface components, and a bus. In some embodiments, content customization apparatus 110 communicates with user device 105, content distribution apparatus 120, a database, or a combination thereof via cloud 115.

In some cases, content customization apparatus 110 is implemented on a server. A server provides one or more functions to users linked by way of one or more of various networks, such as cloud 115. In some cases, the server includes a single microprocessor board, which includes a microprocessor responsible for controlling all aspects of the server. In some cases, the server uses microprocessor and protocols to exchange data with other devices or users on one or more of the networks via hypertext transfer protocol (HTTP) and simple mail transfer protocol (SMTP), although other protocols such as file transfer protocol (FTP) and simple network management protocol (SNMP) may also be used. In some cases, the server is configured to send and receive hypertext markup language (HTML) formatted files (e.g., for displaying web pages). In various embodiments, the server comprises a general purpose computing device, a personal computer, a laptop computer, a mainframe computer, a supercomputer, or any other suitable processing apparatus. Content customization apparatus 110 is an example of, or includes aspects of, the corresponding element described with reference to FIG. 2.

Further detail regarding the architecture of content customization apparatus 110 is provided with reference to FIGS. 2-4. Further detail regarding a process for contrastive graph clustering is provided with reference to FIGS. 5-14. Further detail regarding a process for temporal contrastive graph clustering is provided with reference to FIGS. 15-20.

According to some aspects, cloud 115 is a computer network configured to provide on-demand availability of computer system resources, such as data storage and computing power. In some examples, cloud 115 provides resources without active management by user 100. The term “cloud” is sometimes used to describe data centers available to many users over the Internet. Some large cloud networks have functions distributed over multiple locations from central servers. A server is designated an edge server if it has a direct or close connection to a user. In some cases, cloud 115 is limited to a single organization. In other examples, cloud 115 is available to many organizations. In one example, cloud 115 includes a multi-layer communications network comprising multiple edge routers and core routers. In another example, cloud 115 is based on a local collection of switches in a single physical location. According to some aspects, cloud 115 provides communications between user device 105, content customization apparatus 110, content distribution apparatus 120, a database, or a combination thereof.

According to some aspects, content distribution apparatus 120 is implemented on a server similar to content customization apparatus 110. In some embodiments, content distribution apparatus 120 is included in content customization apparatus 110.

According to some aspects, the contrastive graphing system includes a database. A database is an organized collection of data. In some embodiments, the database stores data in a specified format known as a schema. According to some aspects, the database is structured as a single database, a distributed database, multiple distributed databases, an emergency backup database, or a combination thereof. In some cases, a database controller manages data storage and processing in the database. In some cases, a user interacts with the database controller. In other cases, the database controller operates automatically without user interaction. In some aspects, the database is external to content customization apparatus 110 and/or content distribution apparatus 120 and communicates with content customization apparatus 110 and/or content distribution apparatus 120 via cloud 115. In some embodiments, database is included in content customization apparatus 110 and/or content distribution apparatus 120.

FIG. 2 shows an example of a content customization apparatus according to aspects of the present disclosure. Content customization apparatus 200 is an example of, or includes aspects of, the corresponding element described with reference to FIG. 1. In one aspect, content customization apparatus 200 includes processor unit 205, memory unit 210, training component 215, graph neural network 220, clustering component 225, segmentation component 230, and content component 235.

According to some aspects, processor unit 205 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof. In some cases, processor unit 205 is configured to operate a memory array using a memory controller. In other cases, a memory controller is integrated into processor unit 205. In some cases, processor unit 205 is configured to execute computer-readable instructions stored in memory unit 210 to perform various functions. In some embodiments, processor unit 205 includes special purpose components for modem processing, baseband processing, digital signal processing, or transmission processing.

According to some aspects, memory unit 210 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor of processor unit 205 to perform various functions described herein. In some cases, memory unit 210 includes a basic input/output system (BIOS) that controls basic hardware or software operations, such as an interaction with peripheral components or devices. In some cases, memory unit 210 includes a memory controller that operates memory cells of memory unit 210. For example, the memory controller may include a row decoder, column decoder, or both. In some cases, memory cells within memory unit 210 store information in the form of a logical state.

According to some aspects, training component 215 receives a graph including a node. In some examples, training component 215 computes a contrastive learning loss based on a node embedding. In some examples, training component 215 updates parameters of a graph neural network (GNN) based on the contrastive learning loss.

In some examples, training component 215 identifies node features of the node for a positive sample. In some examples, training component 215 identifies node features of a different node of the graph for a negative sample. In some examples, training component 215 computes a node feature loss based on the positive sample and the negative sample, where the contrastive learning loss includes the node feature loss.

In some examples, training component 215 identifies an edge of the graph. In some examples, training component 215 identifies a neighboring node as a positive sample based on the edge. In some examples, training component 215 identifies a non-neighboring node as a negative sample. In some examples, training component 215 identifies a node triangle based on the edge and the node, where the neighboring node is identified based on the node triangle. In some examples, training component 215 computes a network homophily loss based on the positive sample and the negative sample, where the contrastive learning loss includes the network homophily loss.

In some examples, training component 215 identifies a first node cluster and a second node cluster, where the first node cluster is associated with the node. In some examples, training component 215 identifies a positive sample based on the first node cluster. In some examples, training component 215 identifies a negative sample based on the second node cluster. In some examples, training component 215 computes a hierarchical community loss based on the positive sample and the negative sample, where the contrastive learning loss includes the hierarchical community loss.

According to some aspects, training component 215 computes a contrastive learning loss based on the node embedding. In some examples, training component 215 updates parameters of the GNN based on the contrastive learning loss.

In some examples, training component 215 identifies a node of a first graph snapshot of the snapshot segment. In some examples, training component 215 identifies a corresponding node of a second graph snapshot of the snapshot segment for a positive sample. In some examples, training component 215 identifies a non-corresponding node of the second graph snapshot for a negative sample. In some examples, training component 215 computes a temporal consistency loss based on the positive sample and the negative sample, where the contrastive learning loss includes the temporal consistency loss.

According to some aspects, training component includes a critic function (such as a bilinear critic or an inner product critic). In some cases, a critic function is an artificial neural network that, given a set of K independent samples {xᵢ, yᵢ}fᵢ₌₁^{K}, identifies one of the K samples that is drawn together for each xᵢ by assigning a large score to a positive pair (xᵢ, yᵢ) and small scores to negative pairs {(xᵢ, yⱼ)}_{j≠1}^{K}.

According to some aspects, the system maximizes mutual information between a node and an associated community in a learned latent space using multi-level noise contrastive estimation. Mutual information (MI) between two random variables (RVs) measures an amount of information obtained about one RV by observing the other RV. In some cases, the MI between two RVs X and Y, denoted as I (X; Y), is determined according to:

I(X; Y)=E_{p(x,y)}[log(p(x, y)/p(x)p(y))] (1)
where p(x, y) is the joint density of X and Y, and p(x) and p(y) denote the marginal densities of X and Y, respectively. In some cases, representation learning is used by maximizing an MI between a learned representation and different aspects of the data.

In some cases, MI maximization is performed by deriving and maximizing a lower bound on MI due to a difficulty in estimating MI. In some cases, several lower bounds on MI are based on RVs X and Y that have a high MI if samples drawn from the joint density p(x, y) and samples drawn from a product of marginals p(x)p(y) can be distinguished accurately. In an example, InfoNCE is a lower bound of MI in the form of a noise contrastive estimator:

$$I ( X ; Y ) \geq E [ \frac{1}{K} {\sum }_{i = 1}^{K} log \frac{exp ( f ( {x}_{i} , {y}_{i} ) )}{\frac{1}{K} {\sum }_{j = 1}^{K} exp ( f ( {x}_{i} , {y}_{j} ) )} ] {=}^{Δ} {I}_{NCE} ( X ; Y ) \qquad ( 2 )$$

where the expectation is over K independent samples {xᵢ, yᵢ}ᵢ₌₁^{K} from the joint density p(x, y). In some cases, given a set of K independent samples, the critic function ƒ(⋅) identifies one of the K samples xᵢ that are drawn together for each xᵢ, i.e., by assigning a large score to a positive pair (xᵢ, yᵢ) and small scores to other negative pairs {(xᵢ, yⱼ)}_{j≠1}^{K}.

According to some aspects, training component 215 is configured to compute a contrastive learning loss based on the node embedding and update parameters of the GNN based on the contrastive learning loss.

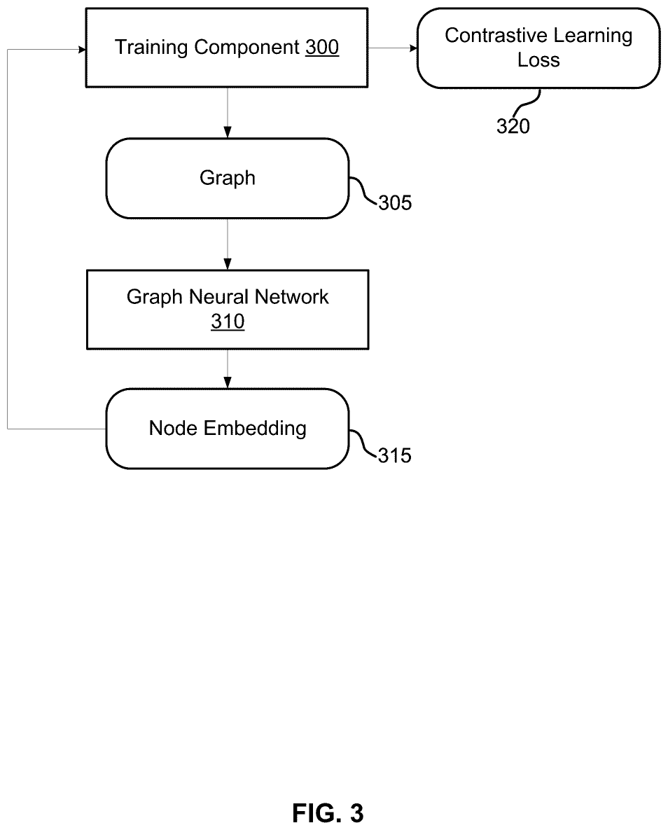

Training component 215 is an example of, or includes aspects of, the corresponding element described with reference to FIG. 3. According to some aspects, training component 215 is implemented as one or more hardware circuits, as firmware, as software stored in memory of memory unit 210 and executed by a processor of processor unit 205, or as a combination thereof.

According to some aspects, GNN 220 generates a node embedding for the node based on the graph. In some examples, GNN 220 computes an updated node embedding for the node based on the updated parameters of the GNN.

According to some aspects, GNN 220 generates a node embedding for each of the set of graph snapshots. In some examples, GNN 220 generates a segment embedding for the snapshot segment.

According to some aspects, GNN 220 includes one or more artificial neural networks (ANNs). An ANN is a hardware or a software component that includes a number of connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes. In some cases, the signals between nodes comprise real numbers, and the output of each node is computed by a function of the sum of its inputs. In some examples, nodes may determine their output using other mathematical algorithms, such as selecting the max from the inputs as the output, or any other suitable algorithm for activating the node. Each node and edge are associated with one or more node weights that determine how the signal is processed and transmitted.

In ANNs, a hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the neural network. Hidden representations are machine-readable data representations of an input that are learned from a neural network's hidden layers and are produced by the output layer. As the neural network's understanding of the input improves as it is trained, the hidden representation is progressively differentiated from earlier iterations.

During a training process of an ANN, the node weights are adjusted to improve the accuracy of the result (i.e., by minimizing a loss which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

According to some aspects, GNN 220 is configured to generate a node embedding for a node based on a graph. According to some aspects, a GNN is a class of deep learning architecture for graphs that produce node embeddings by repeatedly aggregating local node neighborhoods. In some embodiments, a GNN 220 encoder ε maps a graph G and node features F∈ [symbol] into node embeddings H∈ [symbol] for example, ε(G, F)=H.

According to some aspects, GNN 220 is used with a mean aggregator as the node encoder ε:

hᵥ^{l}=ReLU(W_{G}·MEAN({hᵥ^{l-1}}∪{hᵤ^{l-1}|∀u∈ [symbol] (v)})) (3)

In an example, a node v's embedding hᵥ^{l} from an l-th layer of ε is obtained by averaging embeddings of node v and neighbors of node v from a (l−1)-th layer, followed by a linear transformation W_{G} and a rectified linear unit (ReLU) non-linearity. In some embodiments, hᵥ⁰ is initialized to be node features ƒᵥ.

According to some aspects, GNN 220 is implemented such that when the encoder ε of GNN 220 aggregates a neighborhood of a node, more weight is given to neighbor nodes that interacted with the node more recently. Thus, in some cases, GNN 220 adjusts a weight of a neighbor node based on an elapsed time since a latest interaction. In some cases, t_{(u,v)} denotes a time stamp of an edge between nodes u and v, and tᵥ^{max}=max_{u∈N(v)} {t_{(u,v)}} (i.e., the most recent time stamp when node v interacted with neighbor nodes u). In some cases, GNN 220 applies a time decay to a node embedding hᵤ of a neighbor node u, with ψ denoting a time decay factor between 0 and 1:

$$td ( {h}_{u} ) = {ψ}^{{t}_{v}^{{max}_{- {t}_{( u , v )}}}} {h}_{u} \qquad ( 4 )$$

In some cases, a node embedding hᵤ is replaced with a time decayed version td(hᵤ) for time-aware neighborhood aggregation.

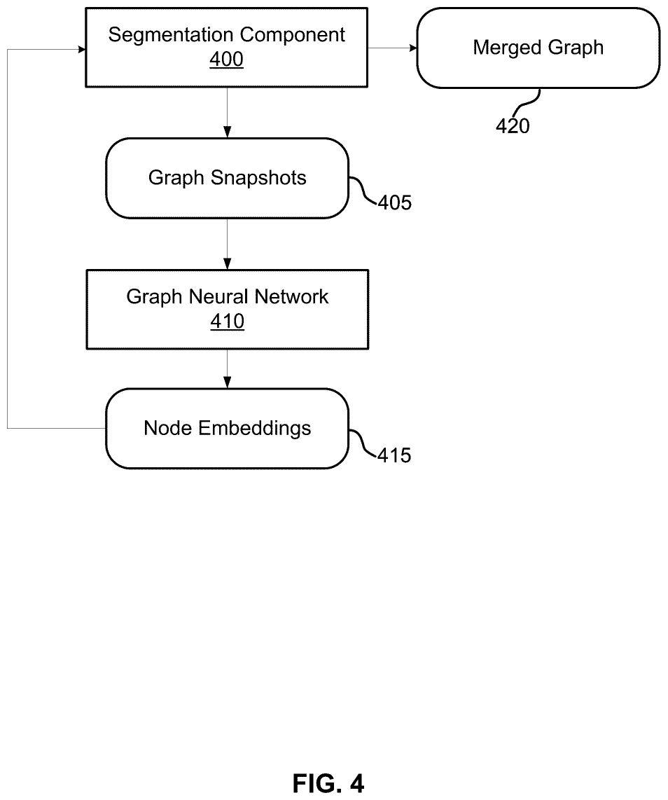

GNN 220 is an example of, or includes aspects of, the corresponding element described with reference to FIGS. 3 and 4. According to some aspects, GNN 220 is implemented as one or more hardware circuits, as firmware, as software stored in memory of memory unit 210 and executed by a processor of processor unit 205, or as a combination thereof.

According to some aspects, clustering component 225 computes a node cluster based on the updated node embedding. In some examples, clustering component 225 computes a cluster centroid based on the node cluster and the updated node embedding. According to some aspects, clustering component 225 clusters nodes of the merged graph to obtain a set of node clusters.

According to some aspects, clustering component 225 is configured to cluster nodes of the graph based on the node embedding. According to some aspects, clustering component 225 is implemented as one or more hardware circuits, as firmware, as software stored in memory of memory unit 210 and executed by a processor of processor unit 205, or as a combination thereof.

According to some aspects, segmentation component 230 receives a set of graph snapshots. In some examples, segmentation component 230 identifies a snapshot segment including a subset of the set of graph snapshots based on the node embedding. In some examples, segmentation component 230 generates a merged graph based on the subset of the set of graph snapshots in the snapshot segment.

In some examples, segmentation component 230 identifies a snapshot of the set of graph snapshots. In some examples, segmentation component 230 computes a distance between the snapshot and the snapshot segment based on the node embedding for the snapshot and the segment embedding for the snapshot segment.

In some examples, segmentation component 230 determines that the distance is less than a threshold distance. In some examples, segmentation component 230 adds the snapshot to the snapshot segment based on the determination. In some examples, segmentation component 230 determines that the distance is greater than a threshold distance. In some examples, segmentation component 230 adds the snapshot to a subsequent snapshot segment based on the determination.

In some examples, segmentation component 230 generates a set of snapshot segments by iterating through the set of graph snapshots and adding a current snapshot either to a current snapshot segment or a next snapshot segment. In some examples, segmentation component 230 generates a set of merged graphs corresponding to the set of snapshot segments, respectively.

According to some aspects, segmentation component 230 is configured to segment a plurality of graph snapshots based on an output of GNN 220. Segmentation component 230 is an example of, or includes aspects of, the corresponding element described with reference to FIG. 4. According to some aspects, segmentation component 230 is implemented as one or more hardware circuits, as firmware, as software stored in memory of memory unit 210 and executed by a processor of processor unit 205, or as a combination thereof.

According to some aspects, content component 235 is configured to provide customized content to a user based on the updated parameters of GNN 220. According to some aspects, content component 235 is implemented as one or more hardware circuits, as firmware, as software stored in memory of memory unit 210 and executed by a processor of processor unit 205, or as a combination thereof.

According to some aspects, content component 235 is omitted from content customization apparatus 200 and is implemented in another device (such as the content distribution apparatus as described with reference to FIG. 1). In this case, content component 235 communicates with content customization apparatus 200 to perform the functions described herein. According to some aspects, content component 235 is implemented as one or more hardware circuits, as firmware, as software stored in memory of the other device and executed by a processor of the other device, or as a combination thereof.

FIG. 3 shows a first example of data flow in a contrastive graphing system according to aspects of the present disclosure. The example shown includes training component 300, graph 305, graph neural network 310, node embedding 315, and contrastive learning loss 320. Training component 300 is an example of, or includes aspects of, the corresponding element described with reference to FIG. 2. Graph neural network 310 is an example of, or includes aspects of, the corresponding element described with reference to FIGS. 2 and 4.

Referring to FIG. 3, training component 300 provides graph 305 to graph neural network 310. Graph neural network 310 computes node embedding 315 for a node included in graph 305. Training component 300 receives node embedding 315 and computes contrastive learning loss 320 based on node embedding 315.

FIG. 4 shows a second example of data flow in a contrastive graphing system according to aspects of the present disclosure. The example shown includes segmentation component 400, graph snapshots 405, graph neural network 410, node embeddings 415, and merged graph 420. Segmentation component 400 is an example of, or includes aspects of, the corresponding element described with reference to FIG. 2. Graph neural network 410 is an example of, or includes aspects of, the corresponding element described with reference to FIGS. 2 and 3.

Referring to FIG. 4, segmentation component 400 provides graph snapshots 405 to graph neural network 410. Graph neural network 410 computes node embeddings 415 for each of graph snapshots 405. Graph neural network 410 provides node embeddings 415 to segmentation component 400, and segmentation component 400 computes merged graph 420 based on node embeddings 415.

### Contrastive Graph Clustering

A method for contrastive graphing is described with reference to FIGS. 5-14. One or more aspects of the method include receiving a graph including a node; generating a node embedding for the node based on the graph using a graph neural network (GNN); computing a contrastive learning loss based on the node embedding; and updating parameters of the GNN based on the contrastive learning loss.

Some examples of the method further include identifying node features of the node for a positive sample. Some examples further include identifying node features of a different node of the graph for a negative sample. Some examples further include computing a node feature loss based on the positive sample and the negative sample, wherein the contrastive learning loss includes the node feature loss.

Some examples of the method further include identifying an edge of the graph. Some examples further include identifying a neighboring node as a positive sample based on the edge. Some examples further include identifying a non-neighboring node as a negative sample. Some examples further include computing a network homophily loss based on the positive sample and the negative sample, wherein the contrastive learning loss includes the network homophily loss.

Some examples of the method further include identifying a node triangle based on the edge and the node, wherein the neighboring node is identified based on the node triangle. Some examples of the method further include identifying a first node cluster and a second node cluster, wherein the first node cluster is associated with the node. Some examples further include identifying a positive sample based on the first node cluster. Some examples further include identifying a negative sample based on the second node cluster. Some examples further include computing a hierarchical community loss based on the positive sample and the negative sample, wherein the contrastive learning loss includes the hierarchical community loss.

Some examples of the method further include computing an updated node embedding for the node based on the updated parameters of the GNN. Some examples further include computing a node cluster based on the updated node embedding. Some examples of the method further include computing a cluster centroid based on the node cluster and the updated node embedding. Some examples of the method further include providing customized content to a user based on the updated parameters of the GNN.

FIG. 5 shows an example of providing customized content according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 5, a user interacts with another entity, such as a third-party user (e.g., organization), a physical location, a computing device, software, a website, or any other person or thing that is capable of interacting with another person or thing. In some cases, the user interaction is added to a graph in which entities are represented by nodes and interactions between entities are represented as edges between nodes. In some cases, a content customization apparatus receives the graph and uses contrastive learning techniques to assign a node embedding corresponding to the user to a cluster of node embeddings. The content customization apparatus provides the cluster assignment to a content distribution apparatus. Based on the cluster assignment, the content distribution apparatus provides customized content to the user.

At operation 505, the system receives a user interaction. In some cases, the operations of this step refer to, or may be performed by, a content customization apparatus as described with reference to FIGS. 1 and 2. In some cases, the user interacts with another entity. In an example, a user interacts with a restaurant by “checking in” to the physical location of the restaurant via an app included on a user device. In some cases, a graph construction apparatus receives the user interaction and adds the interaction to a graph. In an example, the graph includes nodes corresponding to the user and the restaurant, and an edge connecting the nodes that is representative of data generated by the interaction. In some cases, the graph includes other nodes corresponding to other entities in a network of entities, and includes other edges corresponding to interactions between the other entities. In some cases, the graph construction apparatus provides the graph to the content customization apparatus. In some cases, the content customization apparatus includes the graph construction apparatus.

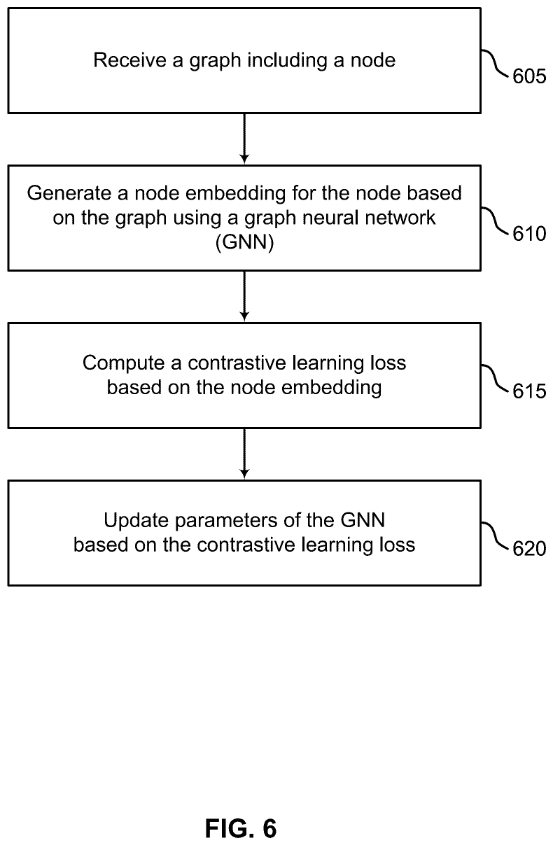

At operation 510, the system trains a graph neural network based on the user interaction. In some cases, the operations of this step refer to, or may be performed by, a content customization apparatus as described with reference to FIGS. 1 and 2. In some cases, the content customization apparatus trains the graph neural network to generate node embeddings corresponding to nodes of the graph according to a contrastive learning loss based on positive and negative samples as described with reference to FIGS. 6-20.

At operation 515, the system clusters the user based on the graph neural network. In some cases, the operations of this step refer to, or may be performed by, a content customization apparatus as described with reference to FIGS. 1 and 2. In some cases, the content customization apparatus assigns a node embedding corresponding to the user and generated by the graph neural network to a cluster of similar node embeddings as described with reference to FIGS. 6-20, thereby identifying one or more communities of entities among the network of entities represented by the graph.

At operation 520, the system provides customized content based on the cluster. In some cases, the operations of this step refer to, or may be performed by, a content distribution apparatus as described with reference to FIG. 1. In some cases, the customized content is content that is tailored to a community of users corresponding to a cluster of node embeddings. In an example, the content distribution apparatus determines that the node embedding corresponding to the user is included in the cluster, and determines that the cluster corresponds to content that is tailored (e.g., customized) for a community of users based on user features associated with the cluster. Based on the determination, the content distribution apparatus provides the customized content to the user.

FIG. 6 shows an example of training a graph neural network according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 6, according to some aspects, the system performs contrastive graph clustering by refining cluster memberships based on current node embeddings and optimizing node embeddings such that nodes from a same cluster are close to each other, while nodes from different clusters are pushed further away from each other. In some cases, contrastive learning is performed while optimizing node embeddings, where positive samples of a node are assumed to belong to a same cluster as a node of interest, whereas negative samples are assumed to belong to different clusters. In some cases, signals at different levels of an input graph are used to effectively construct positive and negative samples for contrastive graph clustering when no cluster membership labels are available. In an example, positive and negative samples for contrastive graph clustering are node features and characteristics of real-world entity networks, such as entity network homophily and hierarchical community structure.

At operation 605, the system receives a graph including a node. In some cases, the operations of this step refer to, or may be performed by, a training component as described with reference to FIGS. 2 and 3.

According to some aspects, the training component receives a graph G=(V ,E) including nodes V={1, . . . , n} and edges E={(uᵢ, vᵢ)|uᵢ, vᵢ∈V}ᵢ₌₁^{m}. In some embodiments, the training component retrieves the graph G from a database as described with reference to FIG. 1. In some embodiments, the training component receives the graph from a graph construction apparatus. In some embodiments, the graph construction apparatus provides the graph G to the database. In some embodiments, the graph construction apparatus is comprised as a component in the content customization apparatus as described with reference to FIGS. 1, 2, and 5. In some embodiments, the graph construction apparatus is included in a separate computing device from the content customization apparatus.

According to some aspects, the graph construction apparatus receives data corresponding to an interaction between one or more entities as an input and outputs a graph G including a node and an edge in response to the input. In some embodiments, an entity comprises a user, a third-party user (such as an organization), a physical location, a computing device, software, a website or any other person or thing that is capable of interacting with another person or thing. In some embodiments, the node corresponds to an entity, and the edge corresponds to an interaction between one or more nodes. In some embodiments, an edge connects one or more nodes in the graph G.

According to some aspects, F∈ [symbol] is a node feature matrix for the graph G. In some embodiments, the node feature matrix F includes a node feature that corresponds to a node. In some embodiments, a node feature includes data that is descriptive of an entity that corresponds to a node (e.g., an identifier, a location, a characteristic, an attribute, a category identifier, a classification, etc.). In some embodiments, the node feature is a vector representation of the descriptive data. In some embodiments, the graph construction apparatus generates the node feature matrix F based on the data corresponding to the interaction between the one or more entities. In some embodiments, the graph construction apparatus stores the node feature matrix F in the database. In some embodiments, the node feature matrix F is associated with the graph G according to a data schema. In some embodiments, the graph construction apparatus provides the node feature matrix F to the training component.

In some embodiments, k is a number of node clusters corresponding to one or more nodes of the graph G. In some embodiments, a cluster is a group of one or more similar nodes. In some embodiments, a cluster membership represents an assignment of a node to a cluster. In some embodiments, a cluster membership ϕᵤ∈ [symbol] of a node u is a stochastic vector that adds up to one, where an i-th entry in the cluster membership ϕᵤ is a probability of node u belonging to an i-th cluster. Accordingly, a node belongs to at least one cluster, and can belong to multiple clusters. In some embodiments, a soft cluster membership includes a hard cluster assignment as a special case, in which one node belongs to exactly one cluster.

According to some aspects, the graph G is representative of an entity network and a community of entities. In some embodiments, an entity network is a group of entities such that each entity corresponds to a node V in the graph G. In some embodiments, a community is a group of entities that correspond to the graph G. In some embodiments, a community structure is a group of relations between entities in the group of entities.

At operation 610, the system generates a node embedding for the node based on the graph using a graph neural network (GNN). In some cases, the operations of this step refer to, or may be performed by, a graph neural network as described with reference to FIGS. 2-4. According to some aspects, a node embedding is a vector representation of a node in a node embedding space.

At operation 615, the system computes a contrastive learning loss based on the node embedding. In some cases, the operations of this step refer to, or may be performed by, a training component as described with reference to FIGS. 2 and 3.

A loss function impacts how a machine learning model is trained in an unsupervised or supervised learning model. Specifically, the goal of an unsupervised learning loss function is to measure a difference between a hypothesis function and an input. That is, a loss function is a measure of how different a prediction is from an original input. As an example, a common loss function is a least-squares loss. After computing the loss, the parameters of the model are updated accordingly and a new set of predictions are made during the next iteration.

Unsupervised learning is one of three basic machine learning paradigms, alongside supervised learning and reinforcement learning. Unsupervised learning draws inferences from datasets consisting of input data without labeled responses. Unsupervised learning may be used to find hidden patterns or grouping in data. For example, cluster analysis is a form of unsupervised learning. Clusters may be identified using measures of similarity such as Euclidean or probabilistic distance.

Contrastive learning refers to a type of machine learning in which a model is trained using the selection of positive and negative sample pairs. Contrastive learning can be used in either a supervised or an unsupervised (e.g., self-supervised) training context. A loss function for a contrastive learning model can encourage a model to generate similar results for positive sample pairs, and dissimilar results for negative sample pairs.

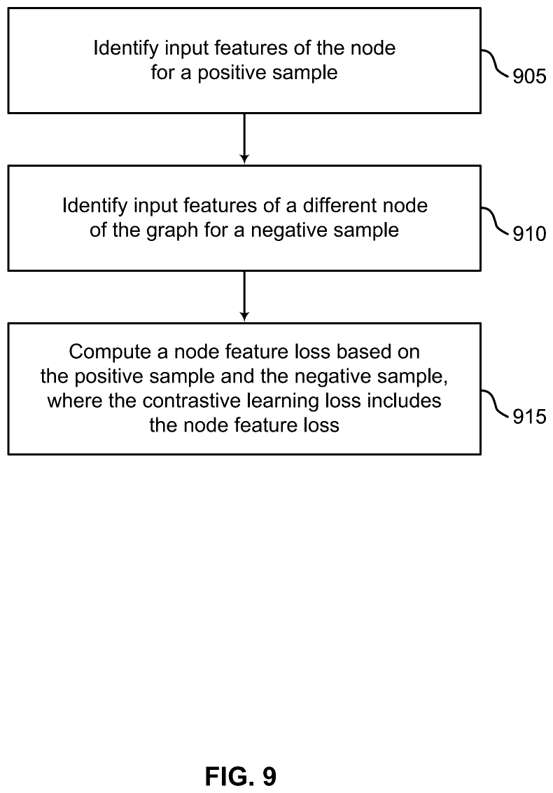

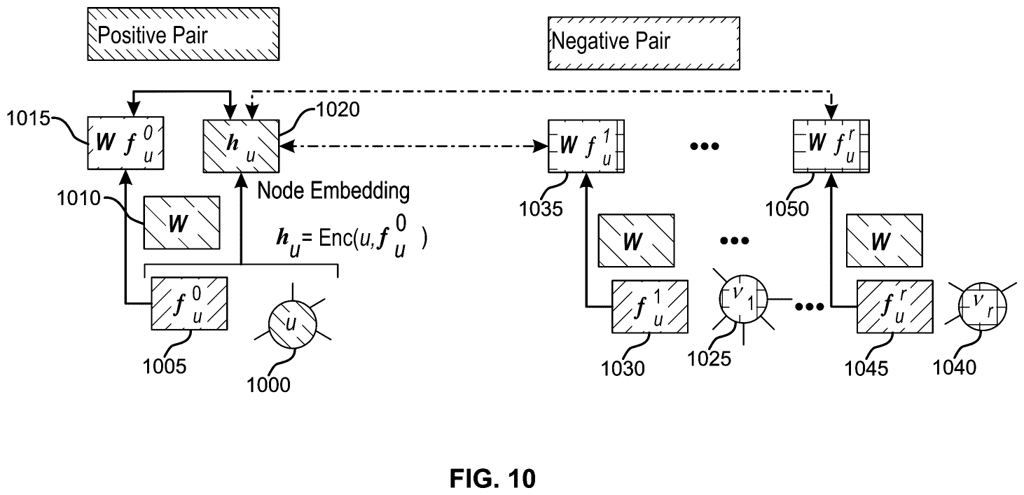

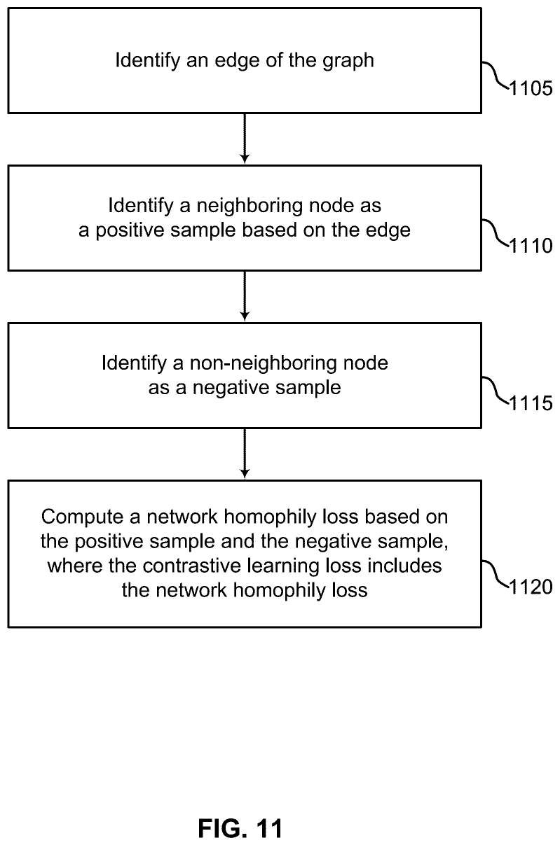

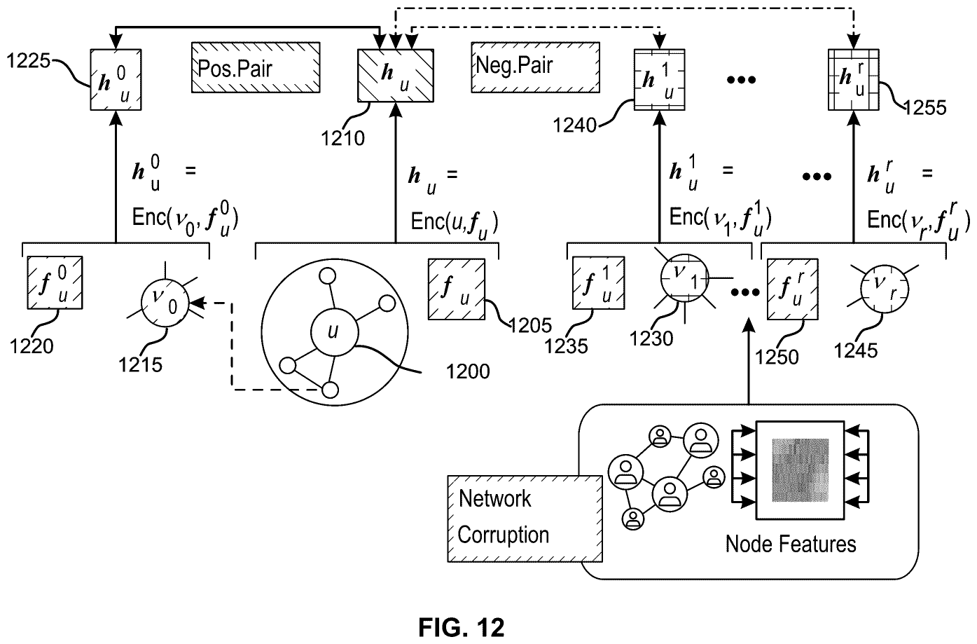

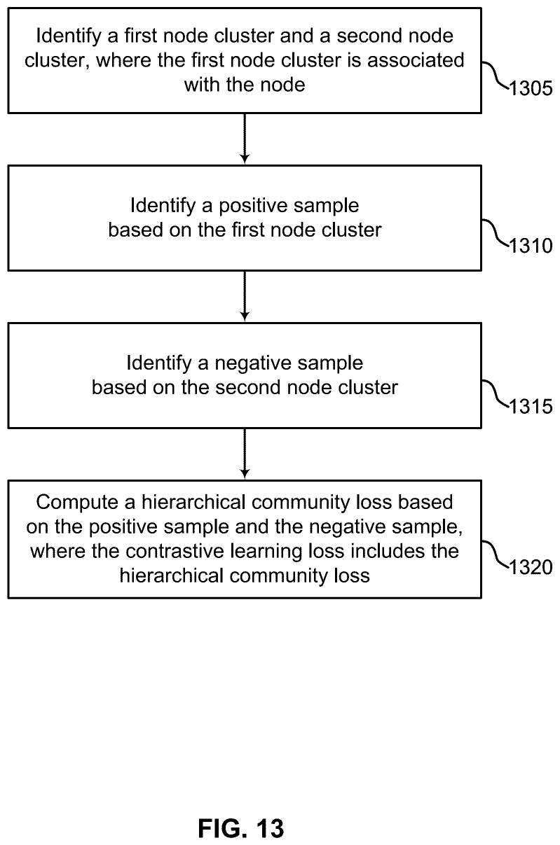

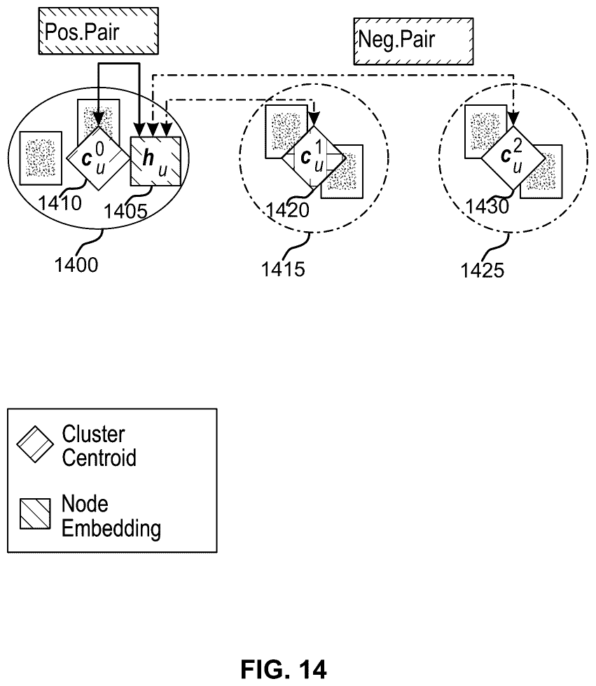

In some cases, the training component computes a node feature loss [symbol] _{F} as described with reference to FIGS. 9-10. In some cases, the training component computes a network homophily loss [symbol] _{H} as described with reference to FIGS. 11-12. In some cases, the training component computes a hierarchical community loss [symbol] _{C} as described with reference to FIGS. 13-14. According to some aspects, the contrastive learning loss [symbol] comprises the node feature loss [symbol] _{F}, the network homophily loss [symbol] _{H}, and the hierarchical community loss [symbol] _{C}:

[symbol]

=λ_{F} [symbol] _{F}+λ_{H} [symbol] _{H}+λ_{C} [symbol] _{C} (5)

In some cases, λ_{F}, λ_{H}, and λ_{C} are weights for the node feature loss [symbol] _{F}, the network homophily loss [symbol] _{H}, and the hierarchical community loss [symbol] _{C}, respectively. In some cases, the contrastive learning loss [symbol] captures signals on the community structure at multiple levels: individual node features via the node feature [symbol] _{F}, neighboring nodes via the network homophily loss [symbol] _{H}, and hierarchically structured communities via the hierarchical community loss [symbol] _{C}. According to some aspects, the training component jointly optimizes the contrastive learning loss [symbol] .

At operation 620, the system updates parameters of the GNN based on the contrastive learning loss. In some cases, the operations of this step refer to, or may be performed by, a training component as described with reference to FIGS. 2 and 3.

According to some aspects, the GNN computes an updated node embedding for the node based on the updated parameters of the GNN. According to some aspects, a clustering component as described with reference to FIG. 2 computes a node cluster based on the updated node embedding. For example, the clustering component assigns the updated node embedding to at least one node cluster using a clustering algorithm (such as a K-means clustering algorithm) as described with reference to FIG. 13. According to some aspects, the clustering component computes a cluster centroid based on the updated node embedding.

Accordingly, given a graph G=(V, E) and node features F∈ [symbol] , the system learns a cluster membership matrix Φ∈ [symbol] for n nodes in G. By iteratively clustering the nodes based on an updated node embeddings, the system learns to group the nodes such that nodes in a same cluster are more similar (e.g., in terms of external node labels if available, or connectivity patterns, node features, and structural roles) than nodes in different clusters, thereby allowing the system to clarify roles and/or personas for entities corresponding to the nodes, and to take further action based on the clarification.

For example, according to some aspects, a content component as described with reference to FIG. 2 provides customized content to a user based on the updated parameters of the GNN. In some cases, the user corresponds to a node of the graph, and the clustering component assigns a node embedding associated with the user to at least one node cluster based on the updated parameters of the GNN. In some cases, the one or more clusters associated with the user are indicative of communities that the user belongs to. In some cases, the content component retrieves content (such as media including video data, visual data, text data, audio data, or a combination thereof; software; information that can be displayed by a graphical user interface; etc.) from a database (such as a database as described with reference to FIG. 1) based on the assignment of the user to a cluster. In this case, the content corresponds to the cluster, and is therefore customized content. In some cases, the content component provides the customized content to the user via a user device as described with reference to FIG. 1.

An example of customized content is a dashboard service that is provided by the content component via a graphical user interface to a user in response to the user being assigned to a cluster. In an example, the dashboard service is used to personalize an attribute ranking according to the user, where the attribute ranking is derived from the graph and the clusters of nodes of the graph to obtain a user-specific personalized score for each of the attributes in the user dataset. In some embodiments, an encoding panel of the dashboard service can be used to suggest an attribute to use to perform a function based on a user's selection of an attribute in the dashboard service.

In some embodiments, a design choice/marks panel of the dashboard service can be used to suggest a specific chart type tailored to the user based on past interactions of the user (as determined according to edges and nodes of the graph), and color, size, and other choices for a design project can be suggested to the user. In some embodiments, a node embedding corresponding to the user can be used along with attribute and design choice embeddings to obtain a personalized ranking of visualizations for the user.

In some embodiments, the customized content includes a suggestion of different services/products to use next (i.e., “next-product prediction”) based on previous behavior of the user and a behavior of users corresponding to node embeddings that are included in same node cluster as a node embedding corresponding to the user. The services/products can be presented in an appropriate and useful manner to help the user find the appropriate service/product to use.

In some embodiments, the customized content includes a personalization of a user experience across a platform of services. For example, services available in a platform can be extrapolated for use in real-world solutions, such as a query service in which the content component suggests relevant attributes (or data tables) to use in a query or to recommend alternative queries to the user based on the assignment of a user to a cluster. Thus, a node embedding of the user can be used along with attribute embeddings to derive a personalized score for every attribute specific to the user.

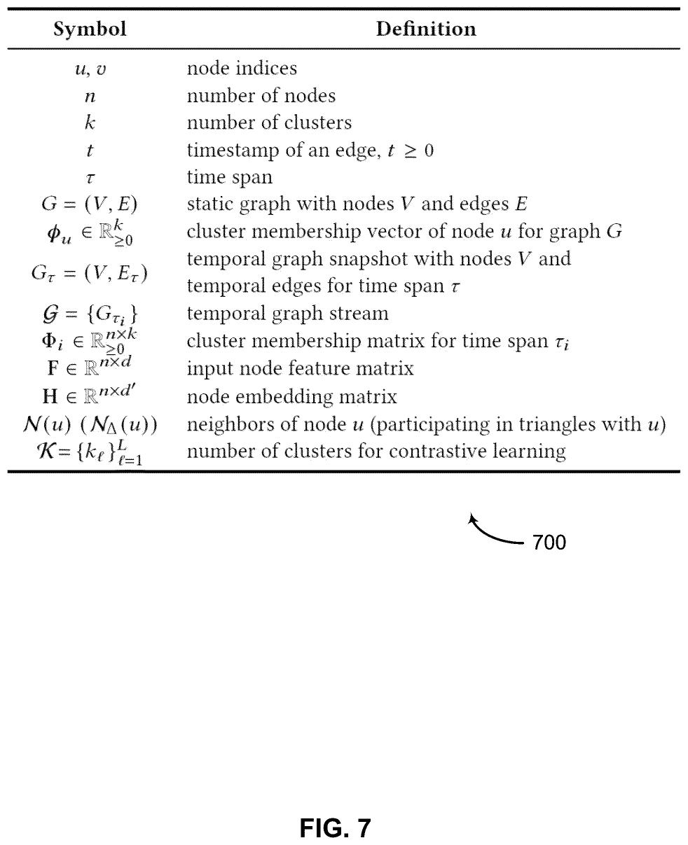

FIG. 7 shows a table of symbols according to aspects of the present disclosure. Table 700 includes symbols as used herein and denotations of the symbols.

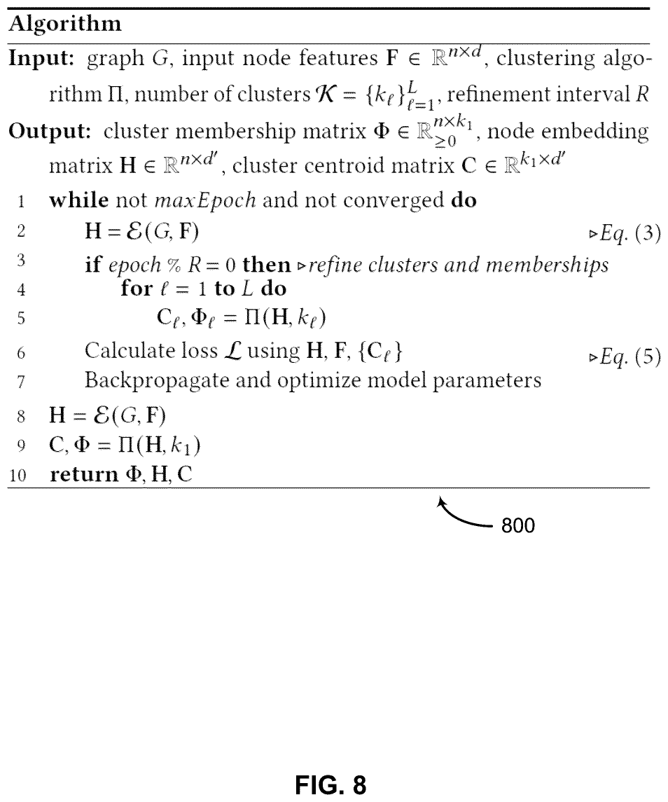

FIG. 8 shows an example of an algorithm for contrastive graph clustering according to aspects of the present disclosure. Referring to FIG. 8, algorithm 800 shows an example process of alternate optimization of cluster memberships and node embeddings. Given current node embeddings H produced by an encoder ε of graph neural network as described with reference to FIG. 2 (line 2), a clustering component as described with reference to FIG. 2 uses a clustering algorithm Π (e.g., a K-means clustering algorithm) to refine cluster centroids { [symbol] } and memberships { [symbol] } (lines 3-5). Based on the updated cluster centroids and memberships, a training component as described with reference to FIG. 2 computes a contrastive learning loss [symbol] and optimizes parameters of the graph neural network (lines 6-7). In some cases, in { [symbol] }, k₁ is assumed to be a number of clusters that are to be identified for the graph.

FIG. 9 shows an example of computing a node feature loss according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 9, entities in a same community tend to have similar attributes. Thus, informative node features can be used to distinguish nodes in a same class from a node in a different class. Node features can be used for sparse graphs, as node features can complement relational information.

Therefore, according to some aspects, for a node u, node features ƒᵤ for the node u are used by a training component as described with reference to FIG. 2 as a positive sample, and for another node v, node features ƒᵥ for the node v are used by the training component as a negative sample. According to some aspects, the training component contrasts the positive and negative samples with a node embedding hᵤ for the node u.

In an example, Sᵤ^{F}={f′ᵤⁱ}ᵢ₌₀^{r} is a set of one positive sample (i=0) and r negative samples (1≤i≤r) for node u, where ′ indicates that sampling is involved. The training component computes a node feature loss [symbol] _{F} using a bilinear critic parameterized by W_{F}∈ [symbol] due to a different dimensionality of node features and latent embeddings:

$${ℒ}_{F} = {\sum }_{u = 1}^{n} - log \frac{exp ( ( {h}_{u} {W}_{F} {f}_{u}^{′0} ) / τ )}{{\sum }_{v = 0}^{r} exp ( ( {h}_{u} {W}_{F} {f}_{u}^{′ v} ) / τ )} \qquad ( 6 )$$

where τ>0 is a temperature hyper-parameter.

At operation 905, the system identifies node features of the node for a positive sample. In some cases, the operations of this step refer to, or may be performed by, a training component as described with reference to FIGS. 2 and 3. For example, referring to FIG. 10, the training component receives the node feature matrix F as described with reference to FIG. 6 and identifies first node features 1005 in the node feature matrix F for first node 1000 as a positive sample.

At operation 910, the system identifies node features of a different node of the graph for a negative sample. In some cases, the operations of this step refer to, or may be performed by, a training component as described with reference to FIGS. 2 and 3. For example, referring to FIG. 10, the training component identifies second node features 1030 through r th node features 1045 in the node feature matrix F for second node 1025 through r^{th} node 1040, respectively, as negative samples.

At operation 915, the system computes a node feature loss based on the positive sample and the negative sample, where the contrastive learning loss includes the node feature loss. In some cases, the operations of this step refer to, or may be performed by, a training component as described with reference to FIGS. 2 and 3. For example, referring to FIG. 10, the training component determines first bilinear critic output 1015 and second bilinear critic output 1035 through r^{th} bilinear critic output 1050 using bilinear critic 1010, receives node embedding 1020 for first node 1000 from the GNN as described with reference to FIG. 2, and computes the node feature loss [symbol] _{F} based on the positive sample and the negative sample according to equation (6).

FIG. 10 shows an example of determining terms for a node feature loss according to aspects of the present disclosure. The example shown includes first node 1000, first node features 1005, bilinear critic 1010, first bilinear critic output 1015, first node embedding 1020, second node 1025, second node features 1030, second bilinear critic output 1035, r^{th} node 1040, r^{th} node features 1045, and r^{th} bilinear critic output 1050.

Referring to FIG. 10, a training component as described with reference to FIG. 2 determines first bilinear critic output 1015 and second bilinear critic output 1035 through r^{th} bilinear critic output 1050 for first node 1000 and second node 1025 through r^{th} node 1040, respectively, based on first node features 1005 and second node features 1030 through r^{th} node features 1045, respectively, using bilinear critic 1010, as described with reference to FIG. 9. A graph neural network as described with reference to FIG. 2 determines first node embedding 1020 based on first node features 1005 as described with reference to FIG. 9.

The training component identifies first node features 1005 as a positive sample for first node 1000 and identifies second node features 1030 through r^{th} node features 1045 as negative samples for first node 1000. The training component computes a node feature loss based on the positive sample and the negative sample as described with reference to FIG. 9.

FIG. 11 shows an example of computing a network homophily loss according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 11, in a graph as discussed herein, similar nodes are more likely to attach to each other than dissimilar nodes, and accordingly, a node is more likely to belong to a same cluster with neighboring nodes rather than a cluster including randomly chosen nodes. Particularly, some entity networks demonstrate higher-order label homogeneity, i.e., a tendency of nodes participating in higher-order structures (e.g., a node triangle in which each vertex is a node and each side is an edge) to share a same label. Thus, a shared label among a group of nodes is a stronger indication of community membership than a connecting edge between a group of nodes. Thus, in some cases, the training component uses edges and node triangles of a graph to construct positive samples. Furthermore, in some cases, the graph neural network generates node embeddings using a neighborhood aggregation scheme that enforces an inductive bias for network homophily that neighboring nodes have similar representations.

At operation 1105, the system identifies an edge of the graph. In some cases, the operations of this step refer to, or may be performed by, a training component as described with reference to FIGS. 2 and 3.

At operation 1110, the system identifies a neighboring node as a positive sample based on the edge. In some cases, the operations of this step refer to, or may be performed by, a training component as described with reference to FIGS. 2 and 3. In some cases, the training component identifies a node triangle based on the edge and the node, where the neighboring node is identified based on the node triangle. In some cases, the training component identifies a node embedding corresponding to the neighboring node as the positive sample.

According to some aspects, [symbol] (u) denotes neighbor nodes of a node u in a graph G, and [symbol] _{Δ}(u) denotes neighbor nodes of the node u that participate in a same node triangle as the node u. Accordingly, [symbol] _{Δ}(u)⊆ [symbol] (u). In some cases, the training component chooses a positive sample (e.g., second node 1215 of FIG. 12) for node u (e.g., first node 1200 of FIG. 12) from among [symbol] (u), with a probability of δ/| [symbol] _{Δ}(u)| for a neighbor node in [symbol] _{Δ}(u), and a probability of (1−δ)/| [symbol] (u)\ [symbol] _{Δ}(u)| for other neighbors nodes, where δ≥0 determines a weight for nodes in [symbol] _{Δ}(u). In some cases, the training component provides the positive sample and the node features for the positive sample (e.g., second node features 1220) to the graph neural network for embedding. In some cases, the graph neural network generates an embedding H=ε(G, F) for the positive sample based on the node features for the positive sample (e.g., second node embedding 1225). In some cases, the training component retrieves the positive sample's embedding from the graph neural network.

At operation 1115, the system identifies a non-neighboring node as a negative sample. In some cases, the operations of this step refer to, or may be performed by, a training component as described with reference to FIGS. 2 and 3.

According to some aspects, the training component designs a network corruption function C(G,F) that constructs a negative network from the original graph G and the node feature matrix F to identify negative samples. In an example, the network corruption function C(⋅) is constructed to return corrupted node features \tilde{F} using row-wise shuffling of F, while preserving the graph G (i.e., C(G, F)=(G, \tilde{F})), thereby randomly relocating nodes over the graph G while maintaining the structure of the graph G.

According to some aspects, the training component randomly chooses r negative samples from among the graph G (e.g., third node 1230 to r^{th} node 1245 of FIG. 12) and provides the r negative samples to the graph neural network for embedding. In some cases, the graph neural network obtains negative node embeddings \tilde{H}∈ [symbol] (e.g., third node embedding 1240 through r^{th} node embedding 1255 of FIG. 12) based on the corrupted node features \tilde{F} for the r negative samples (e.g., third node features 1235 through r^{th} node features 1250). In some cases, the training component retrieves the negative node embeddings H from the graph neural network.

In some cases, the non-neighboring node corresponds to a negative node embedding. In some cases, the non-neighboring node is a node that is not a participant in the node triangle. In some cases, the training component identifies a node embedding corresponding to the non-neighboring node as the negative sample.

At operation 1120, the system computes a network homophily loss based on the positive sample and the negative sample, where the contrastive learning loss includes the network homophily loss. In some cases, the operations of this step refer to, or may be performed by, a training component as described with reference to FIG. 5.

According to some aspects, Sᵤ^{H}={h′ᵤⁱ}ᵢ₌₀^{r} is a set containing embeddings of one positive (i=0) and r negative (1≤i≤r) samples for a node u. In some cases, the training component computes a network homophily loss [symbol] _{H} based on the positive sample and the negative sample:

$${ℒ}_{H} = {\sum }_{u = 1}^{n} - log \frac{exp ( {h}_{u} \cdot {h}_{u}^{′0} ) / τ )}{{\sum }_{v = 0}^{r} exp ( {h}_{u} \cdot {h}_{u}^{′ v} ) / τ )} \qquad ( 7 )$$

where an inner product critic function is used with a temperature hyper-parameter τ>0, and ′ denotes that sampling is involved.

FIG. 12 shows an example of determining terms for a network homophily loss according to aspects of the present disclosure. The example shown includes first node 1200, first node features 1205, first node embedding 1210, second node 1215, second node features 1220, second node embedding 1225, third node 1230, third node features 1235, third node embedding 1240, r^{th} node 1245, r^{th} node features 1250, and r^{th} node embedding 1255.

Referring to FIG. 12, a training component as described with reference to FIG. 2 identifies second node 1215 as a positive sample for first node 1200 as described with reference to FIG. 11. In this case, second node 1215 is included in a node triangle with first node 1200. The training component identifies third node 1230 through r^{th} node 1245 as negative samples for first node 1200 based on a network corruption function as described with reference to FIG. 11.

A graph neural network as described with reference to FIG. 2 generates first node embedding 1210, second node embedding 1225, and third node embedding 1240 through r^{th} node embedding 1255 for first node 1200, second node 1215, and third node 1230 through r^{th} node 1245, respectively, based on first node features 1205, second node features 1220, and third node features 1235 through r^{th} node features 1250, respectively. The training component computes a network homophily loss based on the positive sample and the negative sample as described with reference to FIG. 11.

FIG. 13 shows an example of computing a hierarchical community loss according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 13, the system considers communities at a high level by directly contrasting entities with communities. According to some aspects, the system represents a community as a cluster centroid vector c∈ [symbol] in a same latent space as a node embedding corresponding to an entity so that a distance between an entity and a cluster centroid reflects the entity's degree of participation in the community. In some cases, a cluster centroid is embedded such that the embedding of the cluster centroid reflects an underlying structure of a corresponding community and semantics of input node features to effectively optimize a node embedding by contrasting the node embedding with a cluster centroid embedding corresponding to a community. Accordingly, in some cases, the use of a graph neural network to obtain node embeddings effectively guides an optimization process of the system towards identifying meaningful cluster centroids in an early stage of training.

For example, an entity network can exhibit hierarchical community structures. Thus, according to some aspects, the system groups nodes of a graph into a varying number of clusters. In an example, the system can group the nodes into, e.g., three clusters, and can also group the nodes into, e.g., ten and thirty clusters. Accordingly, in some cases, results of grouping the nodes into the varying number of clusters reveal hierarchical community structures of the entity network in different levels of granularity.

At operation 1305, the system identifies a first node cluster and a second node cluster, where the first node cluster is associated with the node. In some cases, the operations of this step refer to, or may be performed by, a training component as described with reference to FIGS. 2 and 3.

According to some aspects, a clustering component as described with reference to FIG. 2 receives a node embedding for the node from the graph neural network as described with reference to FIG. 2. In some cases, the clustering component assigns the node embedding to a cluster using a clustering algorithm. In some cases, the clustering algorithm is a K-means clustering algorithm. According to some aspects, a K-means clustering algorithm is an unsupervised machine learning algorithm that groups similar data points together to discover underlying patterns by looking for a fixed number (k) of clusters in a dataset. According to some aspects, the clustering component assigns each node embedding of a set of node embeddings to at least one cluster. In some embodiments, the clustering component provides the cluster membership of the node embeddings to a training component as described with reference to FIG. 2.

At operation 1310, the system identifies a positive sample based on the first node cluster. In some cases, the operations of this step refer to, or may be performed by, a training component as described with reference to FIGS. 2 and 3.

According to some aspects, the clustering component computes a cluster centroid for each cluster. A cluster centroid is a vector that contains one number for each node embedding in a cluster, where each number is a mean of a variable for node embeddings in the cluster. In some cases, a cluster centroid is accordingly a multi-dimensional average of a cluster. A maximum distance from a node embedding to a cluster centroid is a measure of variability of the node embeddings within each cluster. A higher maximum value, especially in relation to the average distance, indicates that a node embedding in the cluster lies farther from the cluster centroid.

In some embodiments, the clustering component provides the cluster centroid of each embedding to a training component as described with reference to FIG. 2. According to some aspects, [symbol] ={ [symbol] } [symbol] is a set of a number of clusters of nodes of a graph, and [symbol] ∈ [symbol] is a cluster centroid matrix for each cluster centroid [symbol] . Given node embeddings H and cluster centroids { [symbol] } [symbol] , positive samples for node u are chosen by the training component to be the L cluster centroids that node u belongs to.

At operation 1315, the system identifies a negative sample based on the second node cluster. In some cases, the operations of this step refer to, or may be performed by, a training component as described with reference to FIGS. 2 and 3. In some cases, the training component randomly selects the negative sample from among the other [symbol] −1 cluster centroids for each cluster centroid [symbol] .

At operation 1320, the system computes a hierarchical community loss based on the positive sample and the negative sample, where the contrastive learning loss includes the hierarchical community loss. In some cases, the operations of this step refer to, or may be performed by, a training component as described with reference to FIGS. 2 and 3.

According to some aspects, [symbol] ={ [symbol] } [symbol] is a set with one positive (i=0) and [symbol] negative (1≤i≤ [symbol] ) samples (i.e., cluster centroids) for node u chosen among [symbol] cluster centroids. According to some aspects, the training component computes a hierarchical community loss [symbol] _{C} using an inner product critic “·”:

$${ℒ}_{C} = {\sum }_{u = 1}^{n} - ( \frac{1}{L} {\sum }_{ℓ = 1}^{L} log \frac{exp ( {h}_{u} \cdot {c}_{u , ℓ}^{′0} ) / τ )}{{\sum }_{v = 0}^{{r}_{ℓ}} exp ( {h}_{u} \cdot {c}_{u , ℓ}^{′ v} ) / τ )} ) \qquad ( 8 )$$

FIG. 14 shows an example of determining a hierarchical community loss according to aspects of the present disclosure. The example shown includes first cluster 1400, first node embedding 1405, first cluster centroid 1410, second cluster 1415, second cluster centroid 1420, third cluster 1425, and third cluster centroid 1430.

Referring to FIG. 14, a clustering component as described with reference to FIG. 2 determines first cluster 1400, first cluster centroid 1410, second cluster 1415, second cluster centroid 1420, third cluster 1425, and third cluster centroid 1430 based on first node embedding as described with reference to FIG. 13. A training component as described with reference to FIG. 2 identifies first cluster centroid 1410 as a positive sample for a node associated with first node embedding 1405 and identifies second cluster centroid 1420 and third cluster centroid 1430 as negative samples for the node as described with reference to FIG. 13. The training component computes a hierarchical community loss based on the positive sample and the negative sample as described with reference to FIG. 13.

### Temporal Contrastive Graph Clustering

A method for contrastive graphing is described with reference to FIGS. 15-20. One or more aspects of the method include receiving a plurality of graph snapshots; generating a node embedding for each of the plurality of graph snapshots using a graph neural network (GNN); identifying a snapshot segment including a subset of the plurality of graph snapshots based on the node embedding; and generating a merged graph based on the subset of the plurality of graph snapshots in the snapshot segment.

Some examples of the method further include computing a contrastive learning loss based on the node embedding. Some examples further include updating parameters of the GNN based on the contrastive learning loss.

Some examples of the method further include identifying a node of a first graph snapshot of the snapshot segment. Some examples further include identifying a corresponding node of a second graph snapshot of the snapshot segment for a positive sample. Some examples further include identifying a non-corresponding node of the second graph snapshot for a negative sample. Some examples further include computing a temporal consistency loss based on the positive sample and the negative sample, wherein the contrastive learning loss includes the temporal consistency loss.

Some examples of the method further include identifying a snapshot of the plurality of graph snapshots. Some examples further include generating a segment embedding for the snapshot segment. Some examples further include computing a distance between the snapshot and the snapshot segment based on the node embedding for the snapshot and the segment embedding for the snapshot segment. Some examples of the method further include determining that the distance is less than a threshold distance. Some examples further include adding the snapshot to the snapshot segment based on the determination.

Some examples of the method further include determining that the distance is greater than a threshold distance. Some examples further include adding the snapshot to a subsequent snapshot segment based on the determination. Some examples of the method further include generating a plurality of snapshot segments by iterating through the plurality of graph snapshots and adding a current snapshot either to a current snapshot segment or a next snapshot segment.

Some examples of the method further include generating a plurality of merged graphs corresponding to the plurality of snapshot segments, respectively. Some examples of the method further include clustering nodes of the merged graph to obtain a plurality of node clusters.

FIG. 15 shows an example of generating a merged graph according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 15, an embodiment of the present disclosure performs temporal graph clustering setting to identify communities of entities from time-evolving data. In some cases, the system updates an entity representation and a cluster membership to reflect new information that is available upon an arrival of a new event.

At operation 1505, the system receives a set of graph snapshots. In some cases, the operations of this step refer to, or may be performed by, a segmentation component as described with reference to FIGS. 2 and 4.

According to some aspects, a temporal graph stream [symbol] is a sequence of graph snapshots [symbol] ={G_{τ}_{ᵢ}}ᵢ₌₁^{T} where T is a number of graph snapshots in the stream. In some cases, graph snapshots {G_{τ}_{ᵢ}} are assumed to be non-overlapping and ordered in increasing order of time. In some cases, a temporal graph snapshot G_{τ}=(V, E_{τ}) comprises nodes V={1, . . . , n} and temporal edges E_{τ}={(u, v, t)|u, v∈V, t∈τ}, where t is time (e.g., a timestamp), and τ denotes some time span (e.g., one second, one minute, one hour, etc.). In some cases, a temporal edge E_{τ} of a temporal graph snapshot G_{τ} corresponds to timestamp information included in an interaction between an entity that corresponds to a node of the temporal graph snapshot G_{τ}.

In some cases, the segmentation component receives the temporal graph stream [symbol] from a graph construction apparatus as described with reference to FIG. 6. In some cases, the graph G described with reference to FIG. 6 is an example of a temporal graph snapshot G_{τ}, in which information included in the graph relates to the time span τ.

At operation 1510, the system generates a node embedding for each of the set of graph snapshots using a graph neural network (GNN). In some cases, the operations of this step refer to, or may be performed by, a graph neural network as described with reference to FIGS. 2-4.

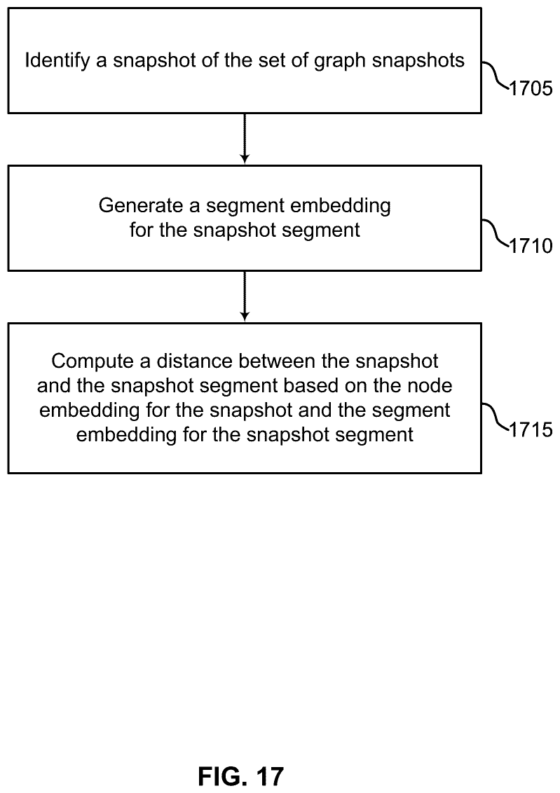

At operation 1515, the system identifies a snapshot segment including a subset of the set of graph snapshots based on the node embedding. In some cases, the operations of this step refer to, or may be performed by, a segmentation component as described with reference to FIGS. 2 and 4. In an example, the segmentation component identifies a subset of temporal graph snapshots included in the temporal graph stream and includes the subset of temporal graph snapshots in the snapshot segment. In some cases, the segmentation component determines whether a subsequent snapshot should be added to the snapshot segment as described with reference to FIG. 17. In some cases, the segmentation component generates a set of snapshot segments by iterating through the set of graph snapshots and adding a current snapshot either to a current snapshot segment or a next snapshot segment.

At operation 1520, the system generates a merged graph based on the subset of the set of graph snapshots in the snapshot segment. In some cases, the operations of this step refer to, or may be performed by, a segmentation component as described with reference to FIGS. 2 and 4. In some cases, the segmentation component generates a set of merged graphs corresponding to the set of snapshot segments, respectively.

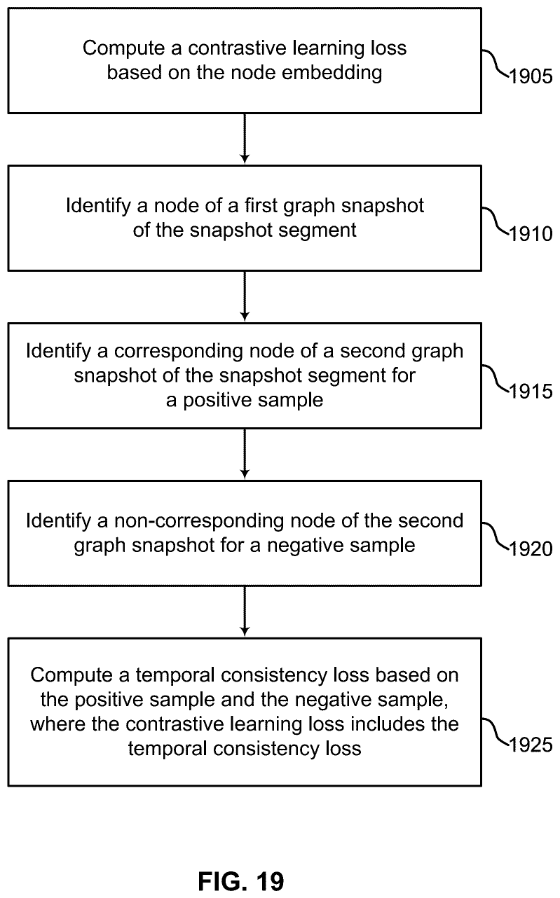

In some cases, the segmentation component generates a merged graph by merging graph snapshots included in the snapshot segment. In some cases, a clustering component as described with reference to FIG. 2 identifies cluster memberships for nodes included in the merged graph as described with reference to FIG. 6. In some cases, the merging process is based on an assumption that new events are similar to previous events. In some cases, a merged graph G_{i:j} is a temporal graph that merges the segment snapshots {G_{τ}_{ᵢ}, . . . , G_{τ}_{ⱼ}} (i.e., G_{i:j}=(V, E_{i:j})), where E_{i:j}=Uₒ₌ᵢ^{j}E_{τ}_{ₒ}. In some cases, the system updates parameters of the graph neural network according to a temporal consistency loss as described with reference to FIG. 19.

Accordingly, in some cases, as the segmentation component receives a graph snapshot G_{τ}_{ᵢ} in a temporal graph stream [symbol] ={G_{τ}_{₁}, . . . , G_{τ}_{ᵢ₌₁}}, the graph neural network incrementally updates node embeddings Hᵢ₌₁ and the clustering component incrementally updates cluster memberships Φᵢ₋₁ based on the graph snapshots to reflect new information. Therefore, given a temporal graph stream [symbol] ={G_{τ}_{ᵢ}}ᵢ₌₁^{T} and input node features F∈ [symbol] , the system learns a cluster membership matrix Φᵢ∈ [symbol] for each time span τᵢ. In some cases, the system thus employs a contrastive graph clustering process that accounts for temporal information provided by graph snapshots.

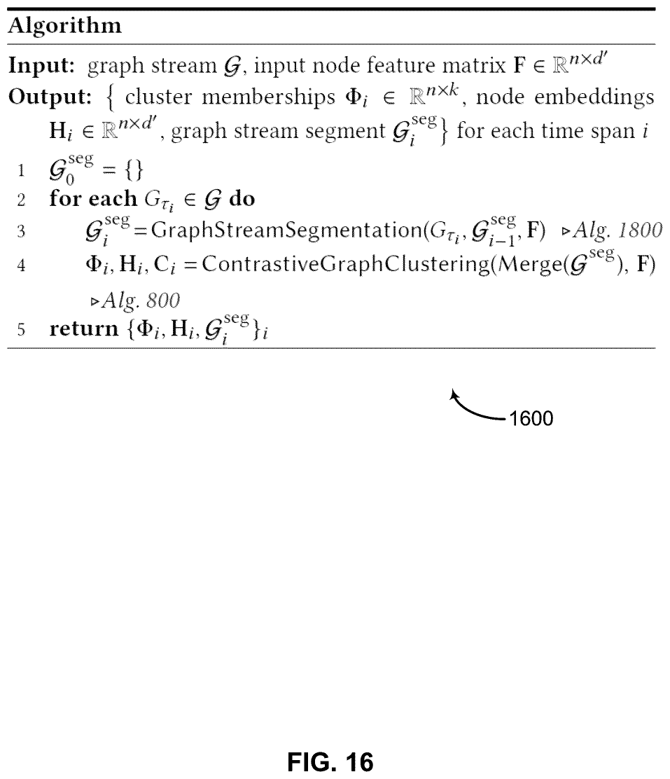

FIG. 16 shows an example of an algorithm for temporal graph clustering according to aspects of the present disclosure. Referring to FIG. 16, algorithm 1600 is an example of the temporal graph clustering process described with reference to FIG. 15.

FIG. 17 shows an example of computing a distance between a snapshot and a snapshot segment according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 17, in some cases, a new graph snapshot may be significantly different from a previous graph snapshot in a temporal graph stream due to changes that occur in an entity network that corresponds to the temporal graph stream. According to some aspects, the system identifies node clusters among snapshots including similar activity patterns to detect changes, milestones, and/or anomalies in the entity network. According to some aspects, [symbol] _{seg}={G_{τ}_{ᵢ}, . . . , G_{τ}_{ⱼ}} is a snapshot segment received by the segmentation component for some i and j (i<j). The snapshot segment [symbol] _{seg} is expanded with a subsequent snapshot G_{τ}_{ⱼ₊₁} if G_{τ}_{ⱼ₊₁} is similar to [symbol] _{seg}. Alternatively, a subsequent snapshot segment including subsequent snapshot G_{τ}_{ⱼ₊₁} and omitting snapshot segment [symbol] _{seg} is started. Thus, the segmentation of the graph stream is a binary decision that can be resolved by comparing embeddings of nodes appearing in both [symbol] _{seg} and G_{τ}_{ⱼ₊₁}.

At operation 1705, the system identifies a snapshot of the set of graph snapshots. In some cases, the operations of this step refer to, or may be performed by, a segmentation component as described with reference to FIGS. 2 and 4.

For example, the segmentation component receives a temporal graph stream including a graph snapshot as described with reference to FIG. 15. In some cases, embeddings of nodes in the subsequent snapshot G_{τ}_{ⱼ₊₁} are similar to embeddings in the snapshot segment [symbol] _{seg} if G_{τ}_{ⱼ₊₁} is similar to [symbol] _{seg}, as embeddings generated by the graph neural network can reflect characteristics of nodes that the graph neural network has learned from an existing snapshot segment. In some cases, a change from the snapshot segment [symbol] _{seg} to the subsequent snapshot G_{τ}_{ⱼ₊₁} leads to a large difference between embeddings of a node in the subsequent snapshot G_{τ}_{ⱼ₊₁} and the snapshot segment [symbol] _{seg}.

At operation 1710, the system generates a segment embedding for the snapshot segment. In some cases, the operations of this step refer to, or may be performed by, a graph neural network as described with reference to FIGS. 2-4. In some cases, V* denotes nodes included in both snapshot segment [symbol] _{seg} and subsequent snapshot G_{τ}_{ⱼ₊₁}. In some cases, the graph neural network receives the snapshot segment [symbol] _{seg} and the subsequent snapshot G_{τ}_{ⱼ₊₁} from the segmentation component and computes segment embedding H_{V*}^{seg}∈ [symbol] for the snapshot segment [symbol] _{seg} and computes subsequent snapshot embedding H_{V*}^{j+1}∈ [symbol] for the subsequent snapshot G_{τ}_{ⱼ₊₁}. According to some aspects, the segment embedding H_{V*}^{seg} includes node embeddings for nodes included in snapshot segment [symbol] _{seg}. According to some aspects, subsequent snapshot embedding H_{V*}^{j+1} includes node embeddings for nodes included in subsequent snapshot G_{τ}_{ⱼ₊₁}.

At operation 1715, the system computes a distance between the snapshot and the snapshot segment based on the node embedding for the snapshot and the segment embedding for the snapshot segment. In some cases, the operations of this step refer to, or may be performed by, a segmentation component as described with reference to FIGS. 2 and 4.

In some cases, the segmentation component computes the distance Dist(⋅, ⋅) between the segment embedding H_{V*}^{seg} and the subsequent snapshot embedding H_{V*}^{j+1} according to:

Dist(H_{V*}^{seg}, H_{V*}^{t+1})=MEAN{d((H_{V*}^{seg})ᵢ, (H_{V*}^{j+1})ᵢ)|i∈V*} (9)

In some cases, the segmentation component determines that the distance Dist is greater than a threshold distance and adds the snapshot to the snapshot segment based on the determination. In some cases, the segmentation component determines that the distance Dist is greater than the threshold distance and adds the snapshot to a subsequent snapshot segment based on the determination.

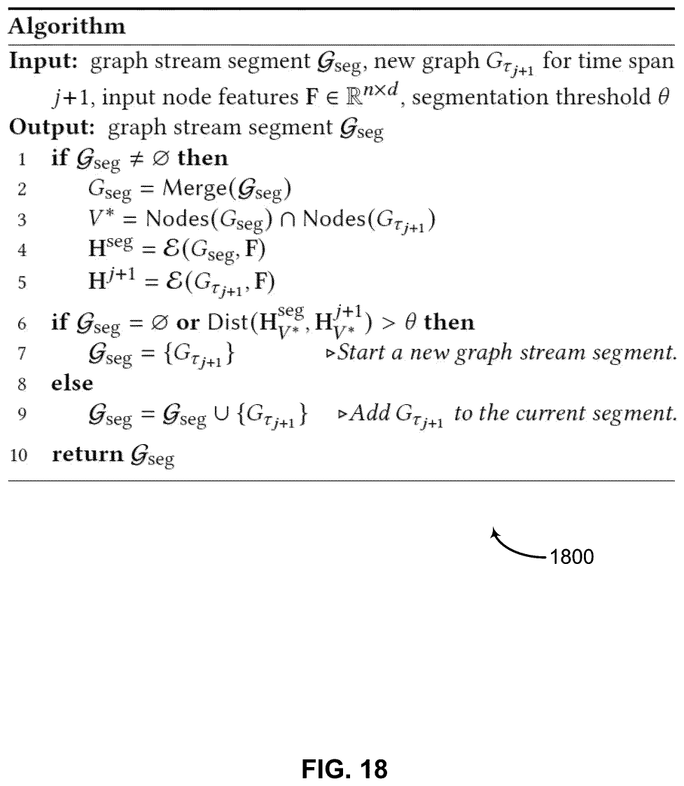

FIG. 18 shows an example of an algorithm for graph stream segmentation according to aspects of the present disclosure. Referring to FIG. 18, algorithm 1800 is an example of the graph stream segmentation process described with reference to FIG. 17.

FIG. 19 shows an example of computing a temporal consistency loss according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 19, characteristics of entities may change over time due to mutual interaction, and such temporal changes may occur smoothly. Thus, for a given temporal graph stream, edges that connect to a node that are observed across a range of time spans can provide similar and related temporal views of the node in terms of a connectivity pattern.

At operation 1905, the system computes a contrastive learning loss based on the node embedding. In some cases, the operations of this step refer to, or may be performed by, a training component as described with reference to FIGS. 2 and 3. In some cases, the training component receives the temporal graph stream, the snapshot segment, and the set of graph snapshots as described with reference to FIG. 15 from the segmentation component. In some cases, the training component computes the contrastive learning loss as described with reference to FIG. 6, based on the node embedding of the node of the graph snapshot. According to some aspects, the training component updates the parameters of a graph neural network as described with reference to FIG. 2 based on the contrastive learning loss.

At operation 1910, the system identifies a node of a first graph snapshot of the snapshot segment. In some cases, the operations of this step refer to, or may be performed by, a training component as described with reference to FIGS. 2 and 3. For example, the training component identifies a node u included in a graph snapshot corresponding to a time span j.

At operation 1915, the system identifies a corresponding node of a second graph snapshot of the snapshot segment for a positive sample. In some cases, the operations of this step refer to, or may be performed by, a training component as described with reference to FIGS. 2 and 3. For example, the training component identifies a node embedding of a node h_{u,j-1} included in a graph snapshot corresponding to a (j−1)-th time span as the positive sample.

At operation 1920, the system identifies a non-corresponding node of the second graph snapshot for a negative sample. In some cases, the operations of this step refer to, or may be performed by, a training component as described with reference to FIGS. 2 and 3.

In some cases, the training component uses a network corruption function as described with reference to FIG. 11 to obtain corrupted node features \tilde{F}, and identifies node u's embedding from corrupted node embeddings ε(G_{i:j-1}, \tilde{F}) as the negative sample. In some cases, multiple negative samples can be obtained using multiple sets of corrupted node features.

At operation 1925, the system computes a temporal consistency loss based on the positive sample and the negative sample, where the contrastive learning loss includes the temporal consistency loss. In some cases, the operations of this step refer to, or may be performed by, a training component as described with reference to FIGS. 2 and 3.

According to some aspects, S_{u,j}^{T}={h′_{u,j-1}ⁱ}ᵢ₌₀^{r} is a set including embeddings of one positive (i=0) and r negative (1≤i≤r) samples of node u for the j-th time span, where ′ denotes the involvement of sampling. In some cases, the training component computes a temporal consistency loss [symbol] _{T} for time span j according to:

$${ℒ}_{T} = {\sum }_{u = 1}^{n} - log \frac{exp ( {h}_{u , j} \cdot {h}_{u , j - 1}^{′0} ) / τ )}{{\sum }_{v = 0}^{r} exp ( {h}_{u , j} \cdot {h}_{u , j - 1}^{′0} ) / τ )} \qquad ( 10 )$$

According to some aspects, the training component combines equation (10) with a weight of λ_{T} and adds the temporal consistency loss [symbol] _{T} to the contrastive learning loss [symbol] :

[symbol]

=λ_{F} [symbol] _{F}+λ_{H} [symbol] _{H}+λ_{C} [symbol] _{C}+λ_{T} [symbol] _{T} (11)

According to some aspects, the training component updates the parameters of the GNN based on the augmented contrastive learning loss.

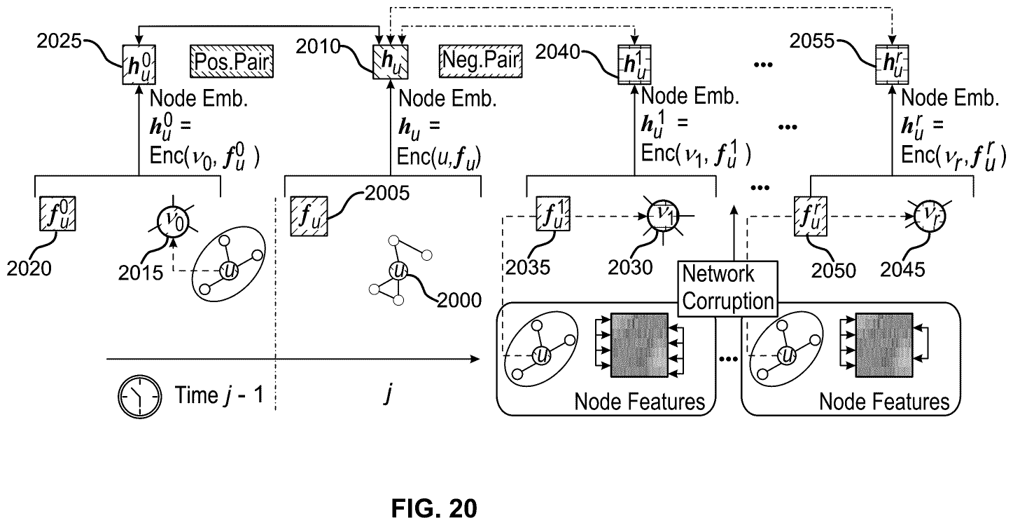

FIG. 20 shows an example of determining a temporal consistency loss according to aspects of the present disclosure. The example shown includes first node 2000, first node features 2005, first node embedding 2010, second node 2015, second node features 2020, second node embedding 2025, third node 2030, third node features 2035, third node embedding 2040, r^{th} node 2045, r^{th} node features 2050, and r^{th} node embedding 2055.

Referring to FIG. 20, a graph neural network as described with reference to FIG. 2 computes first node embedding 2010, second node embedding 2025, and third node embedding 2040 through r^{th} node embedding 2055 for first node 2000, second node 2015, and third node 2030 through r^{th} node 2045, respectively, based on first node features 2005, second node features 2020, and third node features 2035 through r^{th} node features 2050, respectively. The training component selects second node embedding 2025 as a positive sample for first node embedding 2010 and selects third node embedding 2040 through r^{th} node embedding 2055 as negative samples for first node embedding 2010. The training component determines a temporal consistency loss based on the positive sample and the negative samples as described with reference to FIG. 19.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method for contrastive graphing, comprising:
receiving a graph including a node;
generating a node embedding for the node based on the graph using a graph neural network (GNN);
computing a contrastive learning loss based on the node embedding; and
updating parameters of the GNN based on the contrastive learning loss.

2. The method of claim 1, further comprising:
identifying node features of the node for a positive sample;
identifying node features of a different node of the graph for a negative sample; and
computing a node feature loss based on the positive sample and the negative sample, wherein the contrastive learning loss includes the node feature loss.

3. The method of claim 1, further comprising:
identifying an edge of the graph;
identifying a neighboring node as a positive sample based on the edge;
identifying a non-neighboring node as a negative sample; and
computing a network homophily loss based on the positive sample and the negative sample, wherein the contrastive learning loss includes the network homophily loss.

4. The method of claim 3, further comprising:
identifying a node triangle based on the edge and the node, wherein the neighboring node is identified based on the node triangle.

5. The method of claim 1, further comprising:
identifying a first node cluster and a second node cluster, wherein the first node cluster is associated with the node;
identifying a positive sample based on the first node cluster;
identifying a negative sample based on the second node cluster; and
computing a hierarchical community loss based on the positive sample and the negative sample, wherein the contrastive learning loss includes the hierarchical community loss.

6. The method of claim 1, further comprising:
computing an updated node embedding for the node based on the updated parameters of the GNN; and
computing a node cluster based on the updated node embedding.

7. The method of claim 6, further comprising:
computing a cluster centroid based on the node cluster and the updated node embedding.

8. The method of claim 1, further comprising:
providing customized content to a user based on the updated parameters of the GNN.

9. A method for contrastive graphing, comprising:
receiving a plurality of graph snapshots;
generating a node embedding for each of the plurality of graph snapshots using a graph neural network (GNN);
identifying a snapshot segment including a subset of the plurality of graph snapshots based on the node embedding; and
generating a merged graph based on the subset of the plurality of graph snapshots in the snapshot segment.

10. The method of claim 9, further comprising:
computing a contrastive learning loss based on the node embedding; and
updating parameters of the GNN based on the contrastive learning loss.

11. The method of claim 10, further comprising:
identifying a node of a first graph snapshot of the snapshot segment;
identifying a corresponding node of a second graph snapshot of the snapshot segment for a positive sample;
identifying a non-corresponding node of the second graph snapshot for a negative sample; and
computing a temporal consistency loss based on the positive sample and the negative sample, wherein the contrastive learning loss includes the temporal consistency loss.

12. The method of claim 9, further comprising:
identifying a snapshot of the plurality of graph snapshots;
generating a segment embedding for the snapshot segment; and
computing a distance between the snapshot and the snapshot segment based on the node embedding for the snapshot and the segment embedding for the snapshot segment.

13. The method of claim 12, further comprising:
determining that the distance is less than a threshold distance; and
adding the snapshot to the snapshot segment based on the determination.

14. The method of claim 12, further comprising:
determining that the distance is greater than a threshold distance; and
adding the snapshot to a subsequent snapshot segment based on the determination.

15. The method of claim 9, further comprising:
generating a plurality of snapshot segments by iterating through the plurality of graph snapshots and adding a current snapshot either to a current snapshot segment or a next snapshot segment.

16. The method of claim 9, further comprising:
generating a plurality of merged graphs corresponding to the plurality of snapshot segments, respectively.

17. The method of claim 9, further comprising:
clustering nodes of the merged graph to obtain a plurality of node clusters.

18. An apparatus for contrastive graphing, comprising:
a processor;
a memory storing instructions executable by the processor;
a graph neural network (GNN) configured to generate a node embedding for a node based on a graph; and
a training component configured to compute a contrastive learning loss based on the node embedding and update parameters of the GNN based on the contrastive learning loss.

19. The apparatus of claim 18, further comprising:
a clustering component configured to cluster nodes of the graph based on the node embedding.

20. The apparatus of claim 18, further comprising:
a segmentation component configured to segment a plurality of graph snapshots based on an output of the GNN.
